(19) United States
(12) Patent Application Publication
(10) Pub. No.: US 2011/0276602 A1
(43) Pub. Date: Nov. 10, 2011

(54) BUSINESS CARD EXCHANGE INFORMATION PROCESSING APPARATUS, BUSINESS CARD EXCHANGE INFORMATION PROCESSING METHOD, AND PROGRAM

(76) Inventors: Chikahiro Terada, Tokyo (JP); Kenji Shiomi, Tokyo (JP)

(21) Appl. No.: 13/098,521

(22) Filed: May 2, 2011

(30) Foreign Application Priority Data
May 10, 2010 (JP) 2010-108037

(51) Int. Cl. G06F 17/30

(52) U.S. Cl. 707/784; 707/E17.059

(57) ABSTRACT

A business card exchange information processing apparatus includes: a personal user information storage unit in which at least two sets of personal user information, each personal user information including a user identifier, user information, and business card image of a user, can be stored; a business card exchange information storage unit in which at least one set of business card exchange information associating a user identifier with a business card image of a user with whom business cards are exchanged can be stored; an another user contact information accepting unit that accepts, from one user, another user contact information that includes the user identifier of the one user and other user's information relating to another user; and a business card exchange processing unit that, when the another user contact information has been accepted, searches the personal user information storage unit by using the another user contact information, and accumulates, in the business card exchange information storage unit, business card exchange information associating a business card image paired with user information matching the other user's information with the user identifier included in the another user contact information.

This application claims the priority benefit under 35 U.S.C. §119 of Japanese Patent Application No. 2010-108037 filed on May 10, 2010, which is hereby incorporated in its entirety by reference.

### BACKGROUND OF THE INVENTION

1. Field of the Invention

The present invention relates to business card management systems and the like capable of realizing virtual business card exchange.

2. Description of Related Art

There is a conventional business card management system capable of not only managing business cards, but also automatically providing a notice of personnel relocation (see JP 2009-129239A (e.g., page 1 and FIG. 1)). This business card management system includes a relocated person's identifier for identifying a relocated person who is subject to personnel relocation, a relocated person's information accepting unit that accepts a relocated person's information including relocation information that includes at least information indicating that the person has been relocated, a notice receiver's identifier obtaining unit that obtains, from a storage medium, at least one receiver's identifier of at least one receiver who has exchanged business cards with the relocated person identified by the relocated person's identifier included in the relocation person information that has been accepted by the relocated person's information accepting unit, a notification address information obtaining unit that obtains, from a storage medium, at least one set of notification address information that is paired with the at least one receiver's identifier obtained by the notice receiver's identifier obtaining unit, and a relocation information notification unit that notifies, by using the notification address information obtained by the notification address information obtaining unit, relocation information included in the relocated person's information that has been accepted by the relocated person's information accepting unit to the notification address indicated by the notification address information.

### SUMMARY OF THE INVENTION

However, since virtual business card exchange cannot be realized with such a conventional business card management system, it has been difficult to expand a personal network by using information and communication technology.

A first aspect of the present invention is directed to a business card exchange information processing apparatus including a personal user information storage unit in which at least two sets of personal user information can be stored, each set of personal user information including a user identifier that is information for identifying a user, user information that is information relating to the user, and a business card image of the user, a business card exchange information storage unit in which at least one set of business card exchange information can be stored, each set of business card exchange information associating a user identifier with a business card image of a user with whom the user identified by the user identifier has exchanged business cards, an another user contact information accepting unit that accepts, from one user, another user contact information that includes the user identifier of the one user and another user's information, which is information relating to another user, and a business card exchange processing unit that, if the another user contact information accepting unit has accepted another user contact information, searches the personal user information storage unit by using the other user's information included in the another user contact information as a key, and accumulates, in the business card exchange information storage unit, business card exchange information associating a business card image that is paired with user information matching the other user's information with the user identifier included in the another user contact information.

With such a configuration, virtual business card exchange can be realized, and therefore it is possible to further expand a personal network by using information and communication technology.

Furthermore, a second aspect of the present invention is directed to the business card exchange information processing apparatus according to the first aspect, wherein the business card exchange information is information associating with each other a user identifier, a business card image of a user, and related user information, which is information relating to another user who has had contact with the user, and the business card exchange processing unit includes a determination subunit that, if the another user contact information accepting unit has accepted another user contact information, searches the personal user information storage unit by using the other user's information included in the another user contact information as a key, and determines whether or not there is user information matching the other user's information, and a business card exchange processing subunit that, if the determination subunit has determined that there is user information matching the other user's information, accumulates, in the business card exchange information storage unit, business card exchange information associating a business card image that is paired with the user information matching the other user's information with the user identifier included in the another user contact information.

With such a configuration, virtual business card exchange can be realized, and therefore it is possible to further expand a personal network by using information and communication technology.

Furthermore, a third aspect of the present invention is directed to the business card exchange information processing apparatus according to the second aspect, wherein the business card exchange processing unit further includes a related user information accumulation subunit that, if the determination subunit has determined that there is no user information matching the other user's information, accumulates, in the business card exchange information storage unit, the other user's information that is included in the another user contact information as the related user information associated with the user identifier included in the another user contact information that is accepted by the another user contact information accepting unit, or a user registration prompting information sending subunit that, if the determination subunit has determined that there is no user information matching the other user's information, sends information prompting for user registration to a notification address included in the other user's information.

With such a configuration, it is possible to manage information of people with whom the user has contacted, and also, effectively to increase the users of the business card exchange information processing apparatus.

Furthermore, a fourth aspect of the present invention is directed to the business card exchange information processing apparatus according to any one of the first to third aspects, wherein the user information includes user notification address information indicating an address for an inquiry to a user identified by a user identifier, the apparatus further includes a business card exchange asking unit that, if the another user contact information accepting unit has accepted another user contact information, obtains, from the personal user information storage unit, user notification address information that is paired with the other user's information included in the another user contact information, and performs a query as to whether or not to exchange business cards, using the user notification address information, and an answer accepting unit that accepts an answer to the query as to whether or not to exchange business cards, and if the answer accepted by the answer accepting unit is an answer agreeing to exchange business cards, the business card exchange processing unit accumulates, in the business card exchange information storage unit, business card exchange information associating a business card image that is paired with the user information matching the other user's information with the user identifier included in the another user contact information.

With such a configuration, the user can realize virtual business card exchange safely.

Furthermore, a fifth aspect of the present invention is directed to the business card exchange information processing apparatus according to any one of the first to fourth aspects, wherein the personal user information includes a business card image of a user and a password, and the apparatus further includes a password input screen storage unit in which a password input screen for inputting a password is stored, a business card image accepting unit that accepts a business card image of a user, a password input screen sending unit that sends a password input screen to a terminal apparatus after the business card image has been accepted, a password receiving unit that receives a password from the terminal apparatus in response to sending the password input screen, and a user registration unit that accumulates, in the personal user information storage unit, personal user information that includes the business card image received by the business card image accepting unit and the password received by the password receiving unit.

With such a configuration, user registration can be performed easily.

Furthermore, a sixth aspect of the present invention is directed to the business card exchange information processing apparatus according to the fifth aspects, wherein the user registration unit includes a user identifier generation subunit that generates a user identifier such that it is not the same as any other user identifier, and a personal user information accumulation subunit that accumulates, in the personal user information storage unit, personal user information that includes the user identifier generated by the user identifier generation subunit, the business card image received by the business card image accepting unit, and the password received by the password receiving unit.

With such a configuration, user registration can be performed easily.

Furthermore, a seventh aspect of the present invention is directed to the business card exchange information processing apparatus according to the fifth or sixth aspect, wherein the user registration unit further includes a business card recognition subunit that performs character recognition on the business card image and obtains at least one piece of user information from the set consisting of a name, company name, e-mail address, telephone number, fax number and job title, and the personal user information accumulation subunit accumulates, in the personal user information storage unit, personal user information that includes the user information obtained by the business card recognition subunit, the user identifier generated by the user identifier generation subunit, the business card image accepted by the business card image accepting unit, and the password received by the password receiving unit.

With such a configuration, user registration can be performed easily.

Furthermore, an eighth aspect of the present invention is directed to the business card exchange information processing apparatus according to any one of the first to seventh aspects, further including a business card output instruction accepting unit that accepts a business card output instruction instructing to output a business card image of another user with whom business cards have been exchanged, and includes a user identifier, a business card image obtaining unit that, if the business card output instruction has been accepted, obtains at least one business card image associated with the user identifier included in the business card output instruction by using the business card exchange information in the business card exchange information storage unit, and a business card image output unit that outputs the at least one business card image obtained by the business card image obtaining unit.

Furthermore, a ninth aspect of the present invention is directed to a business card exchange information processing apparatus constituting a business card management system that includes a business card exchange information processing apparatus and a server, wherein the business card exchange information processing apparatus includes a personal user information storage unit in which at least two sets of personal user information can be stored, each set of personal user information including a user identifier that is information for identifying a user, user information that is information relating to the user, and a business card image of the user, a business card exchange information storage unit in which at least one set of business card exchange information can be stored, each set of business card exchange information associating a user identifier with a business card image of a user with whom the user identified by the user identifier has exchanged business cards, a user identifier accepting unit that accepts a user identifier, a user identifier sending unit that sends the user identifier to the server, a business card exchange candidate user information receiving unit that receives business card exchange candidate user information from the server in response to sending the user identifier, and a business card exchange processing unit that searches the personal user information storage unit by using one or more sets of the at least one set of user information included in the business card exchange candidate user information that has been received by the business card exchange candidate user information receiving unit as a key, and accumulates, in the business card exchange information storage unit, business card exchange information associating at least one business card image that is paired with user information matching any of the one or more sets of user information with the user identifier, and the server includes a group information storage unit in which at least two sets of group information can be stored, each set of group information associating with each other a user identifier for identifying a user, user information that is information relating to the user, and a group identifier for identifying at least one group to which the user belongs, a user identifier receiving unit that receives a user identifier from the business card exchange information processing apparatus, a business card exchange candidate user information obtaining unit that obtains, from the group information storage unit, business card exchange candidate user information, which is at least one set of user information included in group information having the same group identifier as that paired with the user identifier, and a business card exchange candidate user information sending unit that sends the business card exchange candidate user information obtained by the business card exchange candidate user information obtaining unit to the business card exchange information processing apparatus.

With such a configuration, it is possible to realize virtual business card exchange by using an existing personal network such as SNS. Therefore, it is possible to further expand a personal network by using information and communication technology.

Furthermore, a tenth aspect of the present invention is directed to the business card exchange information processing apparatus according to the ninth aspect, wherein the user information includes user notification address information indicating an address for an inquiry to the user identified by the user identifier, the apparatus further includes a selection screen configuration output unit that configures a selection screen for selecting a user with whom business cards are exchanged by using at least one set of user information included in the business card exchange candidate user information that has been received by the business card exchange candidate user information receiving unit, and outputs the selection screen, a user selection instruction accepting unit that accepts a user selection instruction selecting a user with whom business cards are exchanged, a business card exchange asking unit that obtains at least one set of user notification address information included in at least one set of user information that corresponds to the user selection instruction, and performs a query as to whether or not to exchange business cards by using the user notification address information, and an answer accepting unit that accepts an answer to the query as to whether or not to exchange business cards, and if the answer accepted by the answer accepting unit is an answer agreeing to exchange business cards, the business card exchange processing unit accumulates, in the business card exchange information storage unit, business card exchange information associating a business card image that is paired with the user notification address information corresponding to the answer with the user identifier.

With such a configuration, it is possible to realize virtual business card exchange by using an existing personal network such as SNS. Therefore, it is possible to further expand a personal network by using information and communication technology.

Furthermore, an eleventh aspect of the present invention is directed to the business card exchange information processing apparatus according to the tenth aspect, wherein the query as to whether or not to exchange business cards includes information prompting for a business card exchange and a URI specifying a Web page for inputting the answer.

Furthermore, a twelfth aspect of the present invention is directed to a business card exchange information processing apparatus, including a personal user information storage unit in which at least two sets of personal user information can be stored, each set of personal user information including a user identifier that is information for identifying a user, user information that is information relating to the user, and a business card image of the user, a business card exchange information storage unit in which at least one set of business card exchange information can be stored, each set of business card exchange information associating a user identifier with a business card image of a user with whom the user identified by the user identifier has exchanged business cards, a user identifier accepting unit that accepts a user identifier, a user identifier sending unit that sends the user identifier to a server, a business card exchange candidate user information receiving unit that receives, from the server, business card exchange candidate user information that is at least one set of user information of at least one user belonging to the same group as the user identified by the user identifier in response to sending the user identifier, and a business card exchange processing unit that searches the personal user information storage unit by using one or more sets of the at least one set of user information included in the business card exchange candidate user information that has been received by the business card exchange candidate user information receiving unit as a key, and accumulates, in the business card exchange information storage unit, business card exchange information associating at least one business card image that is paired with user information matching any of the one or more sets of user information with the user identifier.

With such a configuration, it is possible to realize virtual business card exchange by using an existing personal network such as SNS. Therefore, it is possible to further expand a personal network by using information and communication technology.

With the business card management system of the present invention, virtual business card exchange can be realized, and therefore it is possible to expand a personal network by using information and communication technology.

### BRIEF DESCRIPTION OF THE DRAWINGS

FIG. 1 is a conceptual diagram of a business card management system in Embodiment 1.

FIG. 2 is a block diagram of the business card management system in Embodiment 1.

FIG. 3 is a flowchart illustrating the operation of a business card exchange information processing apparatus in Embodiment 1.

FIG. 4 is a flowchart illustrating the operation of business card exchange processing in Embodiment 1.

FIG. 5 is a flowchart illustrating the operation of registration/business card exchange processing in Embodiment 1.

FIG. 6 is a diagram illustrating personal user information management table in Embodiment 1.

FIG. 7 is a diagram illustrating business card exchange information management table in Embodiment 1.

FIG. 8 is a diagram illustrating a password input screen in Embodiment 1.

FIG. 9 is a diagram illustrating a business card image in Embodiment 1.

FIG. 10 is a diagram illustrating inputting on a password input screen in Embodiment 1.

FIG. 11 is a diagram illustrating a personal user information management table in Embodiment 1.

FIG. 12 is a diagram illustrating a business card exchange information management table in Embodiment 1.

FIG. 13 is a diagram illustrating a screen prompting for a business card exchange in Embodiment 1.

FIG. 14 is a diagram illustrating a business card exchange information management table in Embodiment 1.

FIG. 15 is a diagram illustrating a screen output example in Embodiment 1.

FIG. 16 is a diagram illustrating a personal user information management table in Embodiment 1.

FIG. 17 is a diagram illustrating a business card exchange information management table in Embodiment 1.

FIG. 18 is a diagram illustrating a start screen in Embodiment 1.

FIG. 19 is a diagram illustrating an output example of business card images in Embodiment 1.

FIG. 20 is a conceptual diagram of business card management system in Embodiment 2.

FIG. 21 is a block diagram of a business card exchange information processing apparatus in Embodiment 2.

FIG. 22 is a block diagram of a server in Embodiment 2.

FIG. 23 is a flowchart illustrating an operation of a business card exchange information processing apparatus in Embodiment 2.

FIG. 24 is a flowchart illustrating an operation of a first example of server cooperation processing in Embodiment 2.

FIG. 25 is a flowchart illustrating an operation of a second example of the server cooperation processing in Embodiment 2.

FIG. 26 is a diagram illustrating a group information management table in Embodiment 2.

FIG. 27 is a diagram illustrating business card exchange candidate user information in Embodiment 2.

FIG. 28 is a diagram illustrating a selection screen in Embodiment 2.

FIG. 29 is a diagram illustrating a business card exchange information management table in Embodiment 2.

FIG. 30 is a schematic diagram of a computer system in Embodiments 1 and 2.

FIG. 31 is a block diagram of the computer system in Embodiments 1 and 2.

FIG. 32 is a block diagram of a business card exchange information processing system in Embodiment 3.

FIG. 33 is a flowchart illustrating the user registration operation of a business card exchange information processing apparatus in Embodiment 3.

FIG. 34 is a block diagram of another business card exchange information processing apparatus in Embodiment 3.

### DETAILED DESCRIPTION OF THE INVENTION

Hereinafter, embodiments of a business card management system and the like will be described with reference to the drawings. It should be noted that constituent elements denoted by the same reference numerals in the embodiments perform similar operations, and thus a description thereof may not be repeated.

### Embodiment 1

In Embodiment 1, a business card management system capable of realizing virtual business card exchange is described.

Business card images of a plurality of registered users are stored in the business card management system of Embodiment 1, and manages, for each user individually, the business cards of people that the respective users have obtained through business card exchange. In this business card management system, a user exchanges business cards with another user to whom the user has a relation (is related) after the user has input information of the related user (such as an e-mail address and the like), and the business card image of the related user is added to the business card management information of the user (business card exchange processing is performed).

Also, the business card management system performs the above-described business card exchange processing if the system performed a query as to whether or not to exchange business cards, and has accepted an input agreeing to the business card exchange.

Furthermore, the business card management system performs user registration due to accepting a business card image.

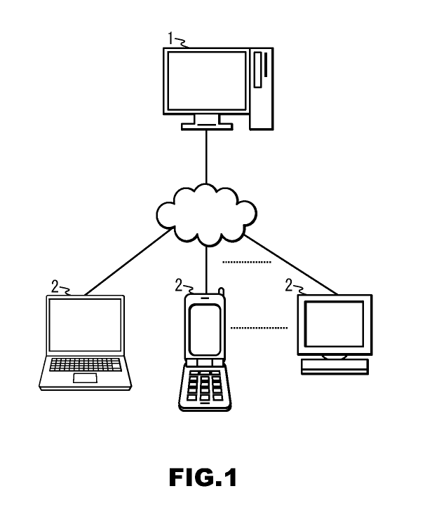

FIG. 1 is a conceptual diagram of the business card management system in Embodiment 1. The business card management system includes a business card exchange information processing apparatus 1 and two or more terminal apparatuses 2. The business card exchange information processing apparatus 1 and the terminal apparatuses 2 are capable of communicating with each other. The business card exchange information processing apparatus 1 and the terminal apparatuses 2 are connected by the Internet, for example. The business card exchange information processing apparatus 1 may be, for example, a web server on the Internet. The terminal apparatuses 2 may be, for example, terminal apparatuses used by users, and may be any apparatuses capable of inputting/outputting information, such as portable terminals, mobile phones, so-called personal computers, and game machines. Note that it is preferable that the terminal apparatuses 2 include a scanner for reading a business card image.

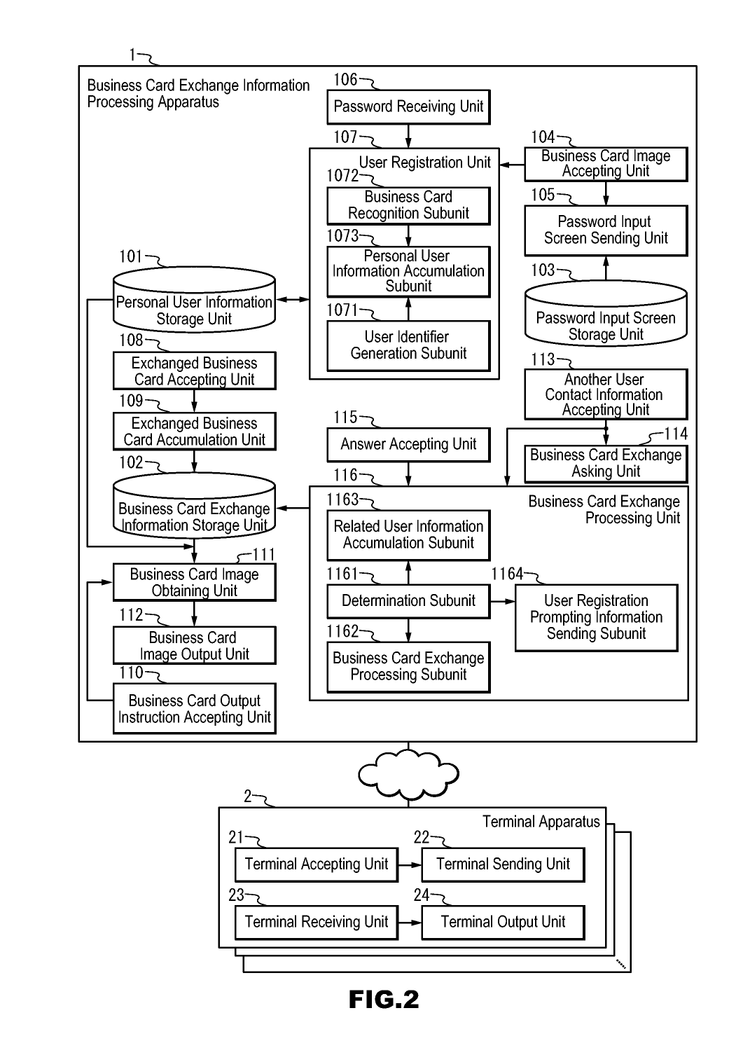

FIG. 2 is a block diagram of the business card management system in Embodiment 1. The business card exchange information processing apparatus 1 includes a personal user information storage unit 101, a business card exchange information storage unit 102, a password input screen storage unit 103, a business card image accepting unit 104, a password input screen sending unit 105, a password receiving unit 106, a user registration unit 107, an exchanged business card accepting unit 108, an exchanged business card accumulation unit 109, a business card output instruction accepting unit 110, a business card image obtaining unit 111, a business card image output unit 112, an another user contact information accepting unit 113, a business card exchange asking unit 114, an answer accepting unit 115 and a business card exchange processing unit 116.

The user registration unit 107 includes a user identifier generation subunit 1071, a business card recognition subunit 1072 and a personal user information accumulation subunit 1073.

The business card exchange processing unit 116 includes a determination subunit 1161, a business card exchange processing subunit 1162, a related user information accumulation subunit 1163, and a user registration prompting information sending subunit 1164.

The terminal apparatus 2 includes a terminal accepting unit 21, a terminal sending unit 22, a terminal receiving unit 23, and a terminal output unit 24.

The personal user information storage unit 101 is capable of having at least two sets of personal user information stored therein. The personal user information includes a user identifier, user information and a business card image of the user. The user identifier is information for identifying a user, for example, a unique ID formed with numerical values or alphanumeric characters, a personal name or the like. The user information is information relating to the user. The user information is, for example, a name, company name, job title, e-mail address, URL of the company, telephone number, and fax number. The user information is generally the information that is indicated on a business card. The business card image is an image obtained by reading a business card, and there is no restriction to the format thereof. Examples of the data format of the business card image include BMP, GIF and JPEG.

The personal user information storage unit 101 preferably is a nonvolatile recording medium, but also may be realized by a volatile recording medium.

There is no restriction to the process by which the personal user information is stored in the personal user information storage unit 101. However, as described later, it is preferable that the personal user information is configured after a business card image and a password have been received from the terminal apparatus 2, and accumulated in the personal user information storage unit 101. Also, for example, the personal user information may be stored in the personal user information storage unit 101 via a recording medium, or personal user information that is input via an input device may be stored in the personal user information storage unit 101.

The business card exchange information storage unit 102 is capable of having at least one set of business card exchange information stored therein. The business card exchange information is information relating to people with whom the user has exchanged business cards. Business card exchange information is information associating a user identifier and a business card image of a user with whom the user identified by the user identifier exchanged business cards. The business card exchange information includes, for example, a user identifier and a business card image of another user with whom the user identified by the user identifier has exchanged business cards. Also, the business card exchange information may also include, for example, a user identifier and information for accessing the business card image of another user with whom the user identified by the user identifier has exchanged business cards (e.g., the user identifier of the other user). Also, the business card exchange information may be a pair of two user identifiers of two users who exchanged business cards, for example. Note that in the case where the business card exchange information is a pair of two user identifiers, it is necessary that business card images of the users identified by the user identifiers can be obtained based on the user identifiers. That is, “associating a user identifier with a business card image” means that it is possible to obtain information of one of the user identifier and the business card image based on information of the other. Note that the business card exchange information may be information that includes, for each user identified by the user identifier, the business card image of another user with whom the user identified by the user identifier exchanged business cards (including virtual business card exchange described below), or information that specifies the business card image (e.g., user identifier).

The business card exchange information storage unit 102 preferably is a non-volatile recording medium, but may be realized by a volatile recording medium. There is no restriction to the process by which the business card exchange information is stored in the business card exchange information storage unit 102. For example, business card exchange information may be stored in the business card exchange information storage unit 102 via a recording medium, or business card exchange information sent via a communication line and the like may be stored in the business card exchange information storage unit 102. Alternatively, business card exchange information input via an input device may be stored in the business card exchange information storage unit 102.

The password input screen storage unit 103 has a password input screen for inputting a password stored therein. The password input screen is information constituting a screen for inputting a password. The password input screen may be realized by any information, for instance, program languages such as HTML, XML, and 4GL, or a bitmap.

The password input screen storage unit 103 preferably is a non-volatile recording medium, but may be realized by a volatile recording medium. There is no restriction to the process by which the password input screen is stored in the password input screen storage unit 103.

The business card image accepting unit 104 accepts business card images of users. “Accept” here generally means receiving by a communication means such as a network, but the accepting means is not limited to this, and may involve receiving by fax, manual acceptance (e.g., by a scanner) of a business card image that has been sent by mail, and the like. The acceptance of the business card image mentioned here generally means acceptance of the business card image for user registration.

After accepting a business card image, the password input screen sending unit 105 sends a password input screen to the terminal apparatus 2. The password input screen sending unit 105 is generally realized by a wireless or wired communication means, but may be realized by a broadcasting means.

The password receiving unit 106 receives a password from the terminal apparatus 2 in response to the sending of the password input screen. The password receiving unit 106 is generally realized by a wireless or wired communication means, but may be realized by a means for receiving broadcasting.

The user registration unit 107 performs user registration processing. Generally, the user registration processing mentioned here is processing in which personal user information including the business card image received by the business card image accepting unit 104 and the password received by the password receiving unit 106 is accumulated in the personal user information storage unit 101. In the user registration processing, user registration to use the business card exchange information processing apparatus 1 is performed. If the information registered by the user registration unit 107 includes user information that includes at least one piece of user information from the set consisting of the name, company name, e-mail address, telephone number, fax number and job title, then the user registration unit 107 may accept manually-input user information, the below-described business card recognition subunit 1072 may obtain user information, or part of the user information that has been manually input may be accepted by the user registration unit 107 and another part of the user information may be obtained by the business card recognition subunit 1072.

The user registration unit 107 can be generally realized by an MPU, memory or the like. The processing procedure of the user registration unit 107 is generally realized by software, and the software for this is recorded in a recording medium such as a ROM. Note that the processing procedure also may be realized by hardware (dedicated circuitry).

The user identifier generation subunit 1071 generates a user identifier such that it is not the same as any other user identifier. Generally, the user identifier is an ID. For example, the user identifier is a numerical value, and the user identifier generation subunit 1071 generates a number obtained by incrementing a currently-largest user identifier by “1”. Also, the user identifier generation subunit 1071 may keep generating a random number until the generated number does not match any of existing user identifiers, and use that random number as the user identifier.

The business card recognition subunit 1072 performs character recognition on the business card image, thereby obtaining user information including at least one of the name, company name, e-mail address, telephone number, fax number and job title. Note that the technique for recognizing the business card image to obtain the name, company name and the like may be a known character recognition technique, and thus is not described here in detail.

The personal user information accumulation subunit 1073 accumulates the personal user information in the personal user information storage unit 101. For example, the personal user information accumulation subunit 1073 accumulates, in the personal user information storage unit 101, personal user information that includes a user identifier generated by the user identifier generation subunit 1071, a business card image accepted by the business card image accepting unit 104, and a password received by the password receiving unit 106. Also, for example, the personal user information accumulation subunit 1073 accumulates, in the personal user information storage unit 101, personal user information that includes user information obtained by the business card recognition subunit 1072, a user identifier generated by the user identifier generation subunit 1071, a business card image accepted by the business card image accepting unit 104, and a password received by the password receiving unit 106. When the personal user information accumulation subunit 1073 accumulates personal user information, it is not necessary for the personal user information to include all attribute values when accumulated, and the respective sets of information constituting the personal user information may be accumulated at different times.

The exchanged business card accepting unit 108 accepts actual business card exchange information that includes a user identifier and a business card image that the user identified by the user identifier has obtained through business card exchange. Specifically, the actual business card exchange information is information that includes the image of a business card of a person with whom business cards have been exchanged. Also, “accept” here generally means receiving by a communication means such as a network, but the accepting means is not limited to this, and may involve acceptance by manual input and the like.

The exchanged business card accumulation unit 109 configures business card exchange information based on the actual business card exchange information accepted by the exchanged business card accepting unit 108, and accumulates the business card exchange information in the business card exchange information storage unit 102. The exchanged business card accumulation unit 109 accumulates, in the business card exchange information storage unit 102, business card exchange information that includes, for example, a user identifier and a business card image accepted by the exchanged business card accepting unit 108. Also, the exchanged business card accumulation unit 109 may search the personal user information storage unit 101 based on the name, company name and the like obtained by performing image recognition on the business card image, for example, and accumulate, in the business card exchange information storage unit 102, the business card exchange information that includes the user identifier of a user identified by the name, company name and the like, and the user identifier accepted by the exchanged business card accepting unit 108. The exchanged business card accumulation unit 109 can be generally realized by an MPU, memory or the like. The processing procedure of the exchanged business card accumulation unit 109 is generally realized by software, and the software for this is recorded in a recording medium such as a ROM. Note that the processing procedure also may be realized by hardware (dedicated circuitry).

The business card output instruction accepting unit 110 accepts a business card output instruction. A business card output instruction is an instruction for outputting a business card image of another user who has exchanged business cards with a certain user, and is an instruction that includes a user identifier. This user identifier is information for identifying the certain user who desires to obtain the business card image of the other user with whom the certain user exchanged business cards. The business card output instruction may be input by any means, such as a keyboard, mouse, and menu screen. The business card output instruction accepting unit 110 can be realized by a device driver of the input means such as a keyboard, menu screen control software, or the like.

When a business card output instruction is accepted, the business card image obtaining unit 111 obtains at least one business card image associated with the user identifier included in the business card output instruction by using the business card exchange information in the business card exchange information storage unit 102. When the business card output instruction is accepted, for example, the business card image obtaining unit 111 obtains, from the personal user information storage unit 101, the business card image associated with one or more user identifiers included in the business card output instruction by using the business card exchange information.

The business card image obtaining unit 111 can be generally realized by an MPU, memory or the like. The processing procedure of the business card image obtaining unit 111 is generally realized by software, and the software for this is recorded in a recording medium such as a ROM. Note that the processing procedure also may be realized by hardware (dedicated circuitry).

The business card image output unit 112 outputs at least one business card image obtained by the business card image obtaining unit 111. Here, “output” generally means sending to the terminal apparatus 2. Note that “output” represents a concept that includes output to a display, projection by a projector, printing with a printer, sending to an outside device, accumulation in a recording medium, delivery of processing results to other processing apparatuses or other programs.

The another user contact information accepting unit 113 accepts another user contact information. The another user contact information includes information of another user (another person) that a certain user has obtained by any means. Information of other person is information with which it is possible to identify the other user, such as an e-mail address. Also, another user contact information includes the user identifier of the certain user and the other user's information, which is information relating to the other user. Also, the other user's information is, for example, information that includes at least one of the name, company name, job title, e-mail address, URL of the company, telephone number, and fax number. The other user's information is information generally indicated on a business card. “Accept” here generally means receiving by a communication means such as a network, but the accepting means is not limited to this, and may involve receiving by fax and acceptance by manual input, for example.

In the case where the another user contact information accepting unit 113 has accepted another user contact information, the business card exchange asking unit 114 obtains user notification address information that is paired with the other user's information included in the another user contact information from the personal user information storage unit 101, and performs a query as to whether or not to exchange business cards by using the user notification address information. A “query” may be performed by sending a screen for answering to the query to the notification address indicated by the user notification address information, or may be performed by sending a message requesting for an answer to the query.

The business card exchange asking unit 114 can be generally realized by an MPU, memory or the like. The processing procedure of the business card exchange asking unit 114 is generally realized by software, and the software for this is recorded in a recording medium such as a ROM. Note that the processing procedure also may be realized by hardware (dedicated circuitry).

The answer accepting unit 115 accepts an answer to the query as to whether or not to exchange business cards. The answer is either an answer permitting business card exchange or an answer refusing business card exchange. “Accept” here generally means receiving by a communication means such as a network, but the accepting means is not limited to this, and may involve receiving by fax and acceptance by manual input, for example.

The business card exchange processing unit 116 performs business card exchange processing. The business card exchange processing is virtual business card exchange processing. That is, in the business card exchange processing, if a business card image of at least one person with whom a certain user has exchanged business cards is output, then business card images of other users with whom a virtual business card exchange has been performed are also output. In the business card exchange processing, if the another user contact information accepting unit 113 has accepted another user contact information, then the personal user information storage unit 101 is searched by using the other user's information included in the another user contact information as a key, and business card exchange information associating the business card image that is paired with user information matching the other user's information with the user identifier included in the another user contact information is accumulated in the business card exchange information storage unit 102.

If the answer accepting unit 115 has accepted an answer permitting business card exchange, then the business card exchange processing unit 116 accumulates, in the business card exchange information storage unit 102, business card exchange information associating the business card image that is paired with user information matching the other user's information with the user identifier included in the another user contact information. Such processing is referred to as business card exchange processing. Note that it is preferable that in the business card exchange processing, the business card exchange information associating the user identifier that is paired with user information matching the other user's information with the business card image that is paired with the user identifier included in the another user contact information is also accumulated in the business card exchange information storage unit 102.

Also, if the answer accepting unit 115 has accepted an answer refusing the business card exchange, then the business card exchange processing unit 116 does not perform the above-described business card exchange processing.

The business card exchange processing unit 116 can be generally realized by an MPU, memory or the like. The processing procedure of the business card exchange processing unit 116 is generally realized by software, and the software for this is recorded in a recording medium such as a ROM. Note that the processing procedure also may be realized by hardware (dedicated circuitry).

If the another user contact information accepting unit 113 has accepted another user contact information, the determination subunit 1161 determines whether there is user information that matches the other user's information included in the another user contact information, in the personal user information storage unit 101. The determination subunit 1161 performs the determination by searching the personal user information storage unit 101 by using the other user's information included in the another user contact information as a key.

If the determination subunit 1161 has determined that there is user information that matches the other user's information, the business card exchange processing subunit 1162 accumulates, in the business card exchange information storage unit 102, business card exchange information associating the business card image that is paired with user information matching the other user's information with the user identifier included in the another user contact information. Furthermore, when the determination subunit 1161 has determined that there is user information that matches the other user's information, the business card exchange processing subunit 1162 may accumulate, in the business card exchange information storage unit 102, the business card exchange information associating the user identifier that is paired with user information matching the other user's information with the business card image that is paired with the user identifier included in the another user contact information.

In the case where the determination subunit 1161 has determined that there is no user information that matches the other user's information, the related user information accumulation subunit 1163 accumulates, in the business card exchange information storage unit 102, the other user's information included in the another user contact information as related user information associated with the user identifier included in the another user contact information that has been accepted by the another user contact information accepting unit 113.

In the case where the determination subunit 1161 has determined that there is user information that matches the other user's information, the user registration prompting information sending subunit 1164 sends information prompting for user registration to the notification address included in the other user's information. Note that the notification address included in the other user's information is, for example, a notification address specified by an e-mail address. The information prompting for user registration may be a message, a screen and the like prompting for user registration. “Send” may be sending by an e-mail, sending of HTML or the like according to a communication protocol such as HTTP, TCP/IP and the like.

The terminal accepting unit 21 accepts information and commands. The information and commands are, for example, the user's own business card image, the actual business card exchange information including the business card image and the user identifier of a person with whom business cards have been exchanged, the another user contact information, the answer to the query as to whether or not to exchange business cards, instructions such as a business card output instruction, and the like. The information and commands may be input by any means, such as a touch panel, numerical keypad, keyboard, mouse, and menu screen. The terminal accepting unit 21 can be realized by a device driver of the input means such as a touch panel, numeric keypad and keyboard, menu screen control software, or the like.

The terminal sending unit 22 sends the information and commands accepted by the terminal accepting unit 21 to the business card exchange information processing apparatus 1. The terminal sending unit 22 is generally realized by a wireless or wired communication means, but may be realized by a broadcasting means.

The terminal receiving unit 23 receives information and commands from the business card exchange information processing apparatus 1. The information and commands are, for example, at least one business card image, a query as to whether or not to exchange business cards, and the like. The terminal receiving unit 23 is generally realized by a wireless or wired communication means, but may be realized by a means for receiving broadcasting.

The terminal output unit 24 outputs the information and commands received from the business card exchange information processing apparatus 1, for example. “Output” here represents a concept that includes output to a display, projection by a projector, printing with a printer, sending to an outside device (e.g., display device), accumulation in a recording medium, delivery of processing results to other processing apparatus or other program. The terminal output unit 24 may or may not include an output device such as a display. The terminal output unit 24 can be realized by a driver software of an output device, or driver software of an output device and an output device, etc.

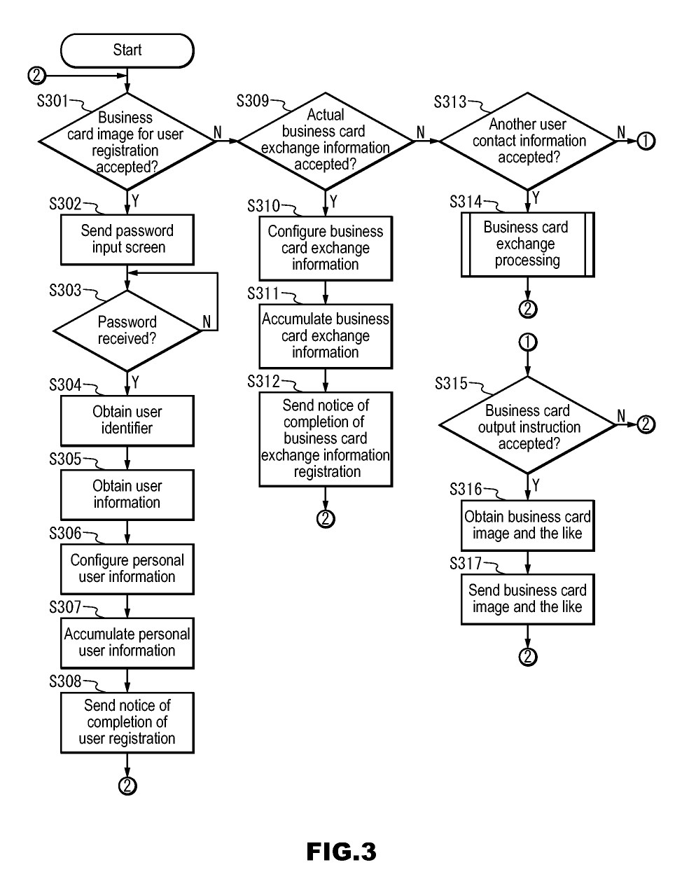

Next, the operation of the business card management system will be described. First, the operation of the business card exchange information processing apparatus 1 is described with reference to the flowchart in FIG. 3.

(Step S301) The business card image accepting unit 104 determines whether it has accepted a business card image of a user for user registration. If a business card image has been accepted, the procedure proceeds to step S302, and if not, the procedure proceeds to step S309.

(Step S302) The password input screen sending unit 105 reads out a password input screen from the password input screen storage unit 103 and sends the password input screen to the terminal apparatus 2.

(Step S303) The password receiving unit 106 determines whether it has received a password from the terminal apparatus 2 in response to the sending of the password input screen in step S302. If a password has been received, the procedure proceeds to step S304, and if not, the procedure returns to step S303. Here, a timeout may occur when a predetermined period of time has passed after the sending of the password input screen, so that the procedure returns to step S301.

(Step S304) The user identifier generation subunit 1071 constituting the user registration unit 107 generates a user identifier such that it is not the same as any other user identifier. Note that in this step, the user registration unit 107 may accept a user identifier that is manually input.

(Step S305) The business card recognition subunit 1072 performs character recognition on the business card image, thereby obtaining user information including at least one of the name, company name, e-mail address, telephone number, fax number and job title. Note that also in this step, the user registration unit 107 may accept user information that is manually input.

(Step S306) The personal user information accumulation subunit 1073 configures personal user information including the user identifier, user information and the business card image.

(Step S307) The personal user information accumulation subunit 1073 accumulates the personal user information configured in step S305 in the personal user information storage unit 101.

(Step S308) The user registration unit 107 or an unshown sending unit sends a notice of completion of user registration to the terminal apparatus 2. The procedure then returns to step S301.

(Step S309) The exchanged business card accepting unit 108 determines whether it has accepted actual business card exchange information. If actual business card exchange information has been accepted, the procedure proceeds to step S310, and if not, the procedure proceeds to step S313.

(Step S310) The exchanged business card accumulation unit 109 configures business card exchange information based on the actual business card exchange information accepted by the exchanged business card accepting unit 108. The exchanged business card accumulation unit 109 configures business card exchange information that includes the user identifier included in the actual business card exchange information and the business card image, for example. Note that the exchanged business card accumulation unit 109 may perform character recognition on the business card image (business card recognition), for example, thereby obtaining user information such as the name and company name, and configure business card exchange information that includes such user information, the user identifier and the business card image.

(Step S311) The exchanged business card accumulation unit 109 accumulates the business card exchange information configured in step S310 in the business card exchange information storage unit 102.

(Step S312) The exchanged business card accumulation unit 109 or an unshown sending unit sends a notice of completion of business card exchange information registration to the terminal apparatus 2. The procedure then returns to step S301.

(Step S313) The another user contact information accepting unit 113 determines whether or not it has accepted another user contact information. If another user contact information has been accepted, the procedure proceeds to step S314, and if not, the procedure proceeds to step S315.

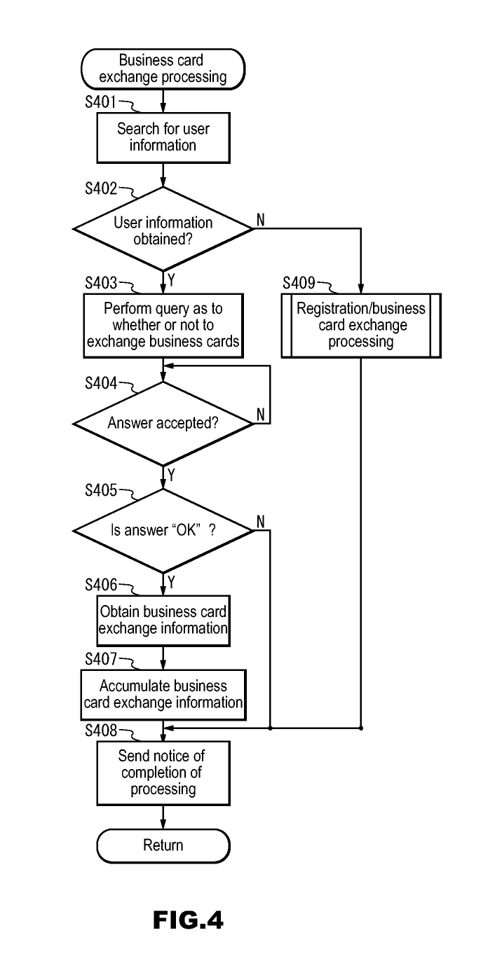

(Step S314) The business card exchange processing unit 116 and the like perform business card exchange processing. The business card exchange processing will be described with reference to the flowchart in FIG. 4. The procedure then returns to step S301.

(Step S315) The business card output instruction accepting unit 110 determines whether it has accepted a business card output instruction. If a business card output instruction has been accepted, the procedure proceeds to step S316, and if not, the procedure returns to step S301.

(Step S316) The business card image obtaining unit 111 obtains at least one business card image associated with the user identifier included in the business card output instruction by using the business card exchange information in the business card exchange information storage unit 102. The business card image obtaining unit 111 may obtain at least one business card image that is paired with the user identifier included in the business card output instruction from the business card exchange information storage unit 102, or may obtain at least one business card image from the personal user information storage unit 101 by using at least one set of information (e.g., a user identifier of another user) that is paired with the user identifier included in the business card output instruction as a key.

(Step S317) The business card image output unit 112 sends at least one business card image obtained in step S316 to the terminal apparatus 2. The procedure then returns to step S301.

Note that in the flowchart of FIG. 3, the processing ends by turning off power or a process-ending interrupt.

Next, the business card exchange processing in step S314 is described with reference to the flowchart in FIG. 4.

(Step S401) If the another user contact information accepting unit 113 has accepted another user contact information, then the determination subunit 1161 constituting the business card exchange processing unit 116 searches the personal user information storage unit 101 for user information (e.g., e-mail address) that matches the other user's information (e.g., e-mail address) included in the another user contact information.

(Step S402) The determination subunit 1161 determines whether or not such user information has been obtained as a result of the search performed in step S401. If the user information has been obtained, the procedure proceeds to step S403, and if not, the procedure proceeds to step S409.

(Step S403) The business card exchange asking unit 114 obtains, from the personal user information storage unit 101, the user notification address information (this may be the other user's information itself included in the another user contact information) that is paired with the other user's information included in the another user contact information, and performs a query as to whether or not to exchange business cards with the user identified by the user identifier included in the another user contact information, to the notification address indicated in the user notification address information. Note that the business card exchange asking unit 114 may perform a query as to whether or not to exchange business cards with the user of the terminal apparatus 2 to the notification address indicated in the user notification address information included in user information in Embodiment 2.

(Step S404) The answer accepting unit 115 determines whether it has accepted an answer to the query as to whether or not to exchange business cards. If an answer has been accepted, the procedure proceeds to step S405, and if not, the procedure returns to step S404. Note that in this step, after completion of the processing in step S403, the processing may return to step S301 without waiting for acceptance of the answer. In such a case, when an answer is accepted, the procedure proceeds to step S405.

(Step S405) The business card exchange processing unit 116 determines whether the answer accepted by the answer accepting unit 115 is “OK”, permitting business card exchange. If the answer is “OK”, the procedure proceeds to step S406, and if not, the procedure proceeds to step S408.

(Step S406) The business card exchange processing subunit 1162 in the business card exchange processing unit 116 obtains business card exchange information associating the business card image that is paired with user information matching the other user's information with the user identifier included in the another user contact information. Here, the business card exchange processing subunit 1162 may obtain the business card image that is paired with the user information matching the other user's information from the personal user information storage unit 101, thereby obtaining business card exchange information that includes that business card image and the user identifier included in the another user contact information, or may obtain the user identifier that is paired with the user information matching the other user's information from the personal user information storage unit 101, thereby obtaining business card exchange information that includes that user identifier and the user identifier included in the another user contact information. Information obtained by the business card exchange processing unit 116 differs depending on the data structure of the business card exchange information.

Also, it is preferable that in step S406, the business card exchange processing subunit 1162 further obtains business card exchange information associating the user identifier that is paired with the user information matching the other user's information with the business card image that is paired with the user identifier included in the another user contact information. That is, it is preferable that in the business card management information of each party to the business card exchange, information including the business card image of the other party is stored.

(Step S407) The business card exchange processing subunit 1162 accumulates the business card exchange information obtained in step S406 in the business card exchange information storage unit 102. Note that it is preferable that in this step, the business card exchange processing subunit 1162 accumulates the business card exchange information of both parties to the business card exchange in the business card exchange information storage unit 102.

(Step S408) The business card exchange processing subunit 1162 or an unshown sending unit sends a notice of completion of processing to the terminal apparatus 2, and the procedure returns to superordinate processing.

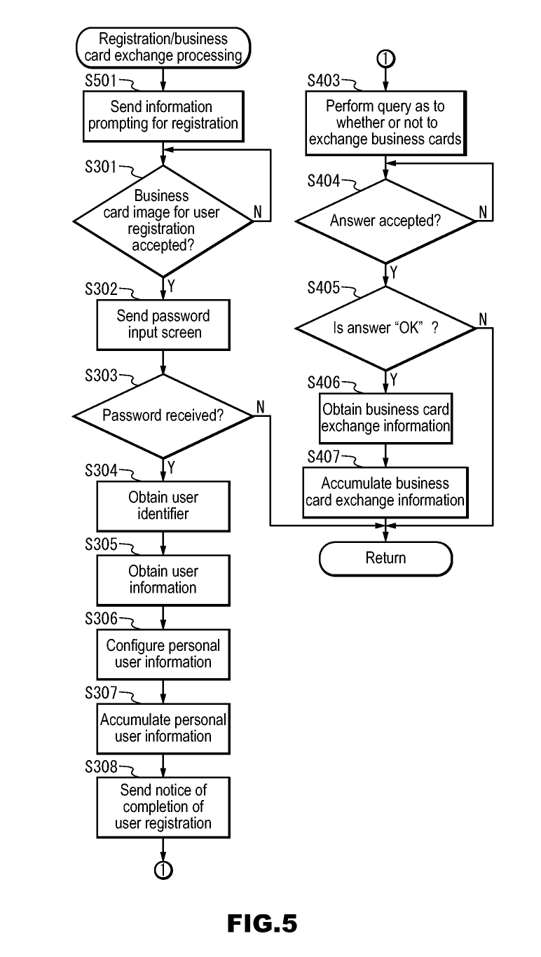

(Step S409) Registration/business card exchange processing is performed. The registration/business card exchange processing is described with reference to the flowchart in FIG. 5. The procedure then proceeds to step S408.

Note that in the flowchart of FIG. 4, in step S409, instead of or in addition to performing the registration/business card exchange processing, the related user information accumulation subunit 1163 may associate the other user's information with the user identifier included in the another user contact information, and accumulate the associated information in the business card exchange information storage unit 102.

Next, the registration/business card exchange processing in step S409 is described with reference to the flowchart in FIG. 5. With respect to the flowchart of FIG. 5, steps that are the same as those in the flowcharts of FIGS. 3 and 4 will not be described.

(Step S501) The user registration prompting information sending subunit 1164 sends information prompting for user registration to the notification address included in the other user's information. The procedure then proceeds to step S301.

Next, the operation of the terminal apparatus 2 is described. The terminal accepting unit 21 of the terminal apparatus 2 accepts information and commands from the user. The information and commands may be, for example, a business card image for user registration and a command for uploading that business card image. The information and commands also may be, for example, actual business card exchange information that includes a user identifier and a business card image that the user has obtained through business card exchange, and a command for sending that actual business card exchange information. The information and commands may also be, for example, another user contact information and a command for sending that another user contact information. “Accept” here generally means acceptance by manual input, but the accepting means is not limited to this, and may involve receiving by a communication means such as a network, loading from a recording medium, for example.

Next, the terminal sending unit 22 sends the information and commands accepted by the terminal accepting unit 21 to the business card exchange information processing apparatus 1.

Then, the terminal receiving unit 23 receives information and the like from the business card exchange information processing apparatus 1 in response to sending by the terminal sending unit 22. Information and the like may be, for example, the fact that user registration has been completed, the fact that registration of business card exchange information has been completed, the fact that virtual business card exchange has been completed, and at least one business card image.

Next, the terminal output unit 24 outputs the information and the like received by the terminal receiving unit 23.

A specific operation of the business card management system in Embodiment 1 is described below. The conceptual diagram of the business card management system is shown in FIG. 1.

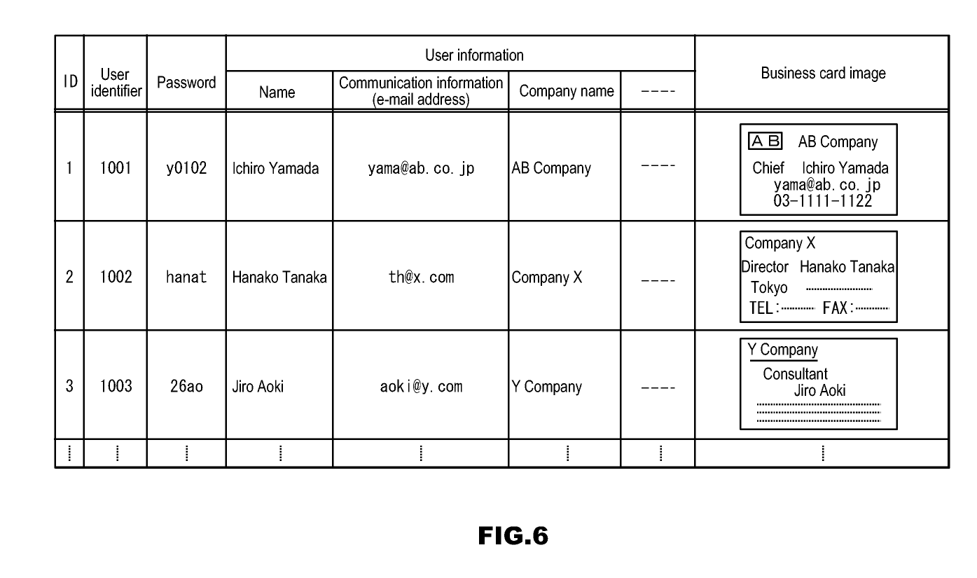

At this time, the personal user information storage unit 101 holds a personal user information management table as shown in FIG. 6 therein. The personal user information management table is for managing information of users who can use the business card exchange information processing apparatus 1 having a business card management function. The personal user information management table manages at least one record, each record including an “ID”, “user identifier”, “password”, “user information”, and “business card image”. “User information” includes the “name”, “notification address information (e-mail address)”, “company name” and the like.

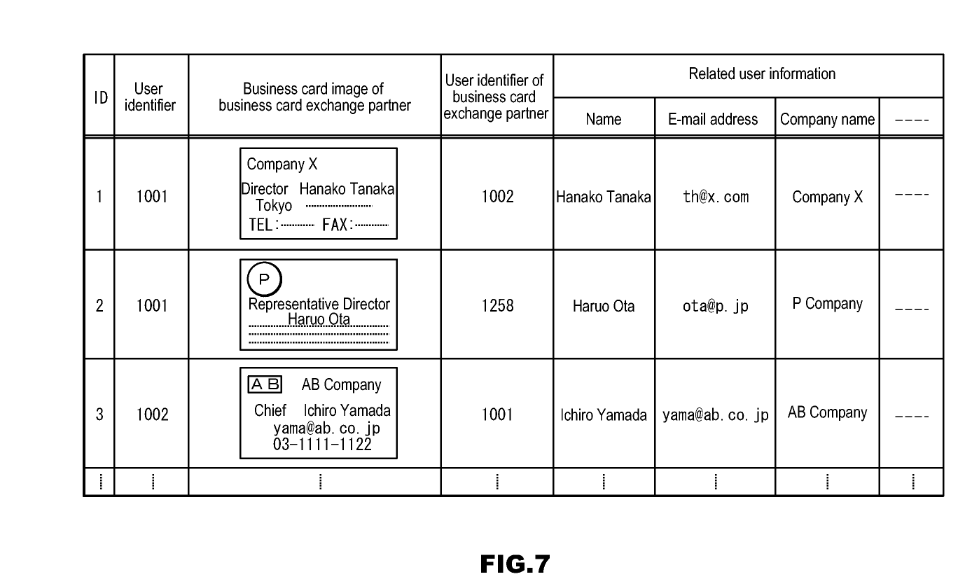

The business card exchange information storage unit 102 holds the business card exchange information management table shown in FIG. 7 therein. The business card exchange information management table is a table for managing business card exchange information. The business card exchange information management table includes an “ID”, “user identifier”, “business card image of a person with whom business cards have been exchanged”, “user identifier of a person with whom business cards have been exchanged” and “related user information”. The “business card image of a person with whom business cards have been exchanged” is the business card image of the person with whom the user identified by the user identifier exchanged business cards. The “user identifier of a person with whom business cards have been exchanged” is the user identifier of the person with whom the user identified by the user identifier exchanged business cards. The “related user information” is information about a person who has some relation to the user identified by the user identifier, for example, a person with whom the user exchanged business cards, a person whom the user met without exchanging business cards, or a person with whom the user had a meeting. The “related user information” includes, in this example, the “name”, “e-mail address”, “company name” and the like. The record of “ID=1” in FIG. 7 indicates that the user whose user identifier is “1001” exchanged business cards with a user whose user identifier is “1002”.

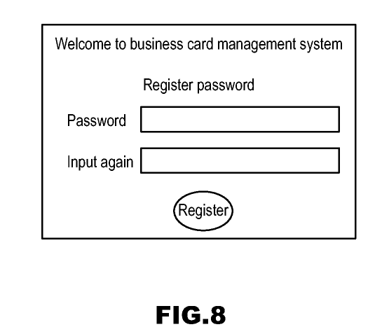

Also, the password input screen storage unit 103 is assumed to have the password input screen shown in FIG. 8 stored therein. The password input screen is written in HTML, for example.

In such a situation, it is assumed that the user “Inoue Hajime” has uploaded his business card image obtained by reading the business card with a scanner of his own terminal apparatus 2, from the terminal apparatus 2 to the business card exchange information processing apparatus 1.

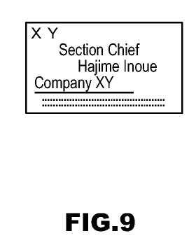

Then, the terminal accepting unit 21 accepts a user registration command including the business card image. Next, the terminal sending unit 22 sends the user registration command including the business card image shown in FIG. 9 to the business card exchange information processing apparatus 1.

Next, the business card image accepting unit 104 of the business card exchange information processing apparatus 1 receives the user registration command including the business card image.

Then, the password input screen sending unit 105 reads out a password input screen from the password input screen storage unit 103, and sends that password input screen to the terminal apparatus 2 that has sent the user registration command.

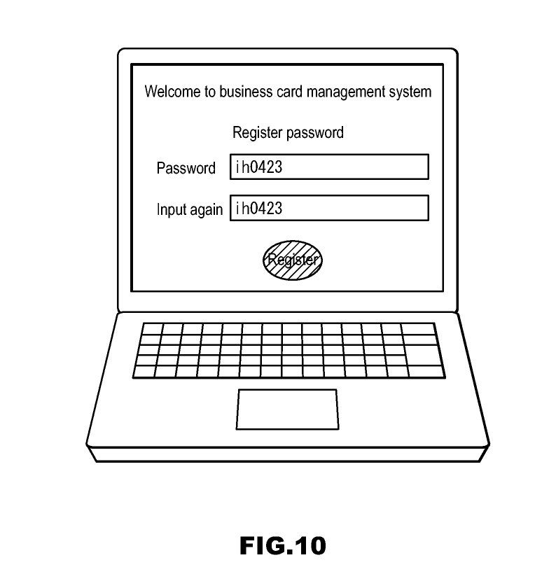

Next, the terminal receiving unit 23 of the terminal apparatus 2 receives the password input screen. The terminal output unit 24 then outputs the password input screen. Next, it is assumed that the user has input his password twice in the password input screen as shown in FIG. 10, and has clicked the “Register” button.

Next, the terminal accepting unit 21 accepts a password sending command including the password “ih0423”. The terminal sending unit 22 then sends the password “ih0423” to the business card exchange information processing apparatus 1.

Next, the password receiving unit 106 of the business card exchange information processing apparatus 1 receives the password “ih0423”.

Next, the user identifier generation subunit 1071 constituting the user registration unit 107 generates a user identifier “1348” such that it is not the same as any other user identifier. Note that in this example, the user identifier generation subunit 1071 generates a new user identifier by incrementing the largest value among the user identifiers by “1”.

Next, it is assumed that the business card recognition subunit 1072 has performed character recognition on the received business card image, thereby obtaining user information such as the name “Inoue Hajime”, company name “Company XY”, e-mail address “ih@xy.jp”, telephone number “06-6111-1234”, fax number “06-6111-1235” and the like. Note that it is preferable that here, the results of the above-described character recognition are manually corrected, or the name and the like indicated in the business card image are manually input.

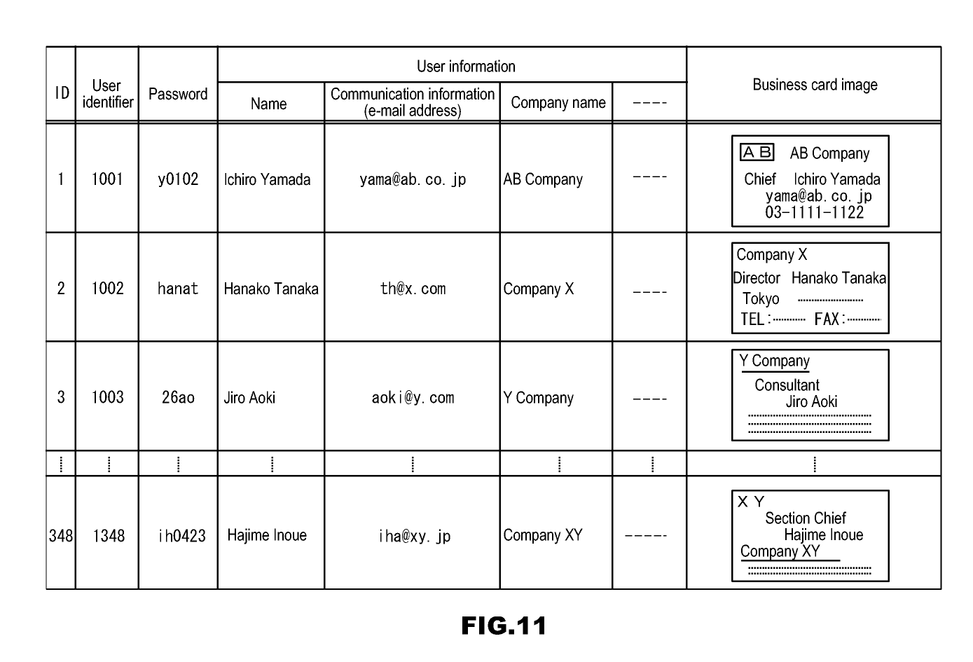

Next, the personal user information accumulation subunit 1073 configures the personal user information “1348, ih0423, Inoue Hajime, ih@xy.jp, Company XY, - - - ”, including the user identifier, password, user information, business card image and the like. Then, the personal user information accumulation subunit 1073 accumulates the configured personal user information in the personal user information management table. As a result, the personal user information management table shown in FIG. 11 is obtained. The business card image is uploaded with the above-described processing, thereby completing user registration.

Next, it is assumed that the user “Inoue Hajime” has exchanged business cards with Mr. Ichiro Yamada of AB Company. The user “Inoue Hajime” captures the image of the business card of Mr. Ichiro Yamada of AB Company, and inputs actual business card exchange information including the captured business card image and the user identifier “1348” to the terminal apparatus 2. Then, the terminal accepting unit 21 of the terminal apparatus 2 accepts the actual business card exchange information, and the terminal sending unit 22 sends the actual business card exchange information to the business card exchange information processing apparatus 1.

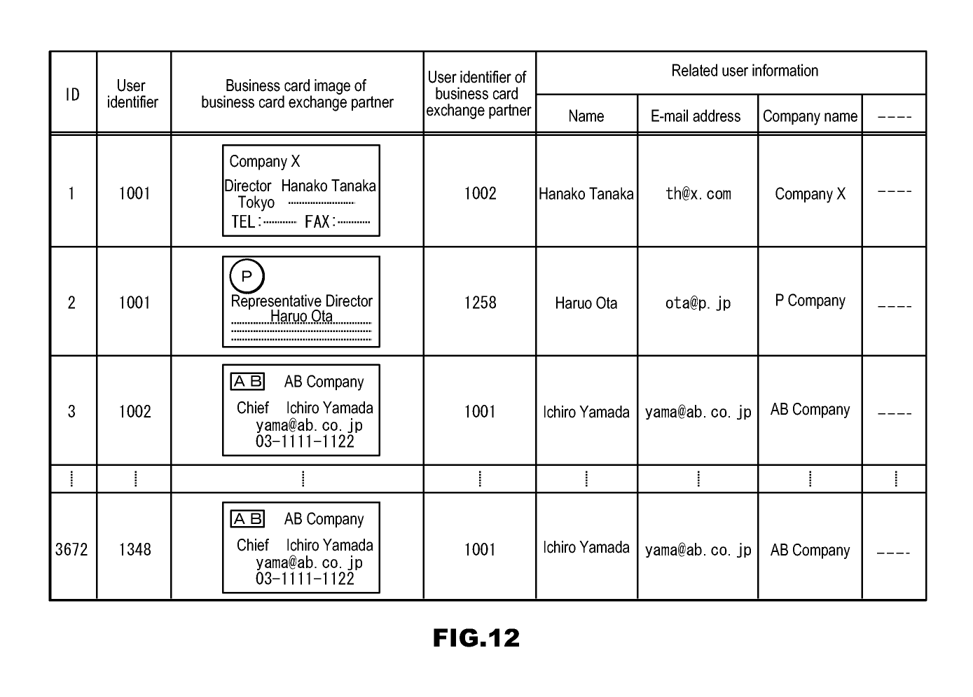

Next, the exchanged business card accepting unit 108 of the business card exchange information processing apparatus 1 receives the actual business card exchange information. Then, the exchanged business card accumulation unit 109 configures the business card exchange information “user identifier: 1348, business card image of Mr. Ichiro Yamada, user identifier of Mr. Ichiro Yamada: 1001, related user information of Mr. Ichiro Yamada” based on the actual business card exchange information received by the exchanged business card accepting unit 108. Note that the exchanged business card accumulation unit 109 performs character recognition on the business card image of Mr. Ichiro Yamada, obtains the name “Yamada Ichiro”, company name “AB Company”, and the like, thereby configuring the business card exchange information. Also, it is preferable that the exchanged business card accumulation unit 109 searches the personal user information management table in FIG. 6 by using part of the information obtained by performing character recognition on the business card image of Mr. Ichiro Yamada (e.g., name) as a key, to obtain the user identifier of Mr. Ichiro Yamada: 1001, and the related user information of Mr. Ichiro Yamada. Next, the exchanged business card accumulation unit 109 accumulates the configured business card exchange information in the business card exchange information management table shown in FIG. 6, thereby obtaining the business card exchange information management table shown in FIG. 12. The exchanged business card accumulation unit 109 then sends a notice of completion of the business card exchange information registration to the terminal apparatus 2.

Next, it is assumed that the user “Inoue Hajime” has been introduced to Ms. Hanako Tanaka, obtained her e-mail address “th@x.com”, and has input another user contact information including the e-mail address to the terminal apparatus 2.

Next, the terminal accepting unit 21 of the terminal apparatus 2 accepts the another user contact information including the user identifier “1348” of the user “Inoue Hajime” and the e-mail address “th@x.com”. Then, the terminal sending unit 22 sends the another user contact information to the business card exchange information processing apparatus 1.

Next, the another user contact information accepting unit 113 receives the another user contact information including the e-mail address “th@x.com”.

Then, the business card exchange processing unit 116 and the like perform business card exchange processing as described below. That is, the determination subunit 1161 constituting the business card exchange processing unit 116 searches the personal user information management table shown in FIG. 11 for user information that matches the other user's information including the e-mail address “th@x.com”. The determination subunit 1161 then obtains the user information of “Tanaka Hanako” from the personal user information management table as a result of the search.

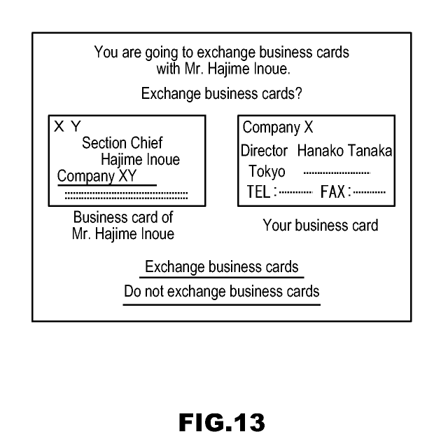

Next, the business card exchange asking unit 114 obtains, from the personal user information management table, the user notification address information “th@x.com” that is paired with the other user's information included in the another user contact information, and performs a query as to whether or not to exchange business cards to the notification address indicated by the user notification address information “th@x.com”. Note that such a query can be performed by, for example, sending an e-mail stating the URL for outputting the Web page shown in FIG. 13 and a message prompting for a business card exchange. Then, it is assumed that “Tanaka Hanako” went to the URL stated in the e-mail and caused the screen shown in FIG. 13 to be displayed in the terminal apparatus 2. Then, it is assumed that “Tanaka Hanako” has clicked the anchor “Exchange business cards” in the screen shown in FIG. 13 by using an input means such as a mouse. Then, the terminal sending unit 22 sends the information “Exchange business cards” accepted by the terminal accepting unit 21 to the business card exchange information processing apparatus 1.

Next, the answer accepting unit 115 accepts the answer agreeing to a business card exchange. The business card exchange processing unit 116 then determines that the answer accepted by the answer accepting unit 115 is “OK”, which permits the business card exchange.

The business card exchange processing subunit 1162 of the business card exchange processing unit 116 obtains business card exchange information associating the business card image (business card image of Ms. Hanako Tanaka) paired with the user information that matches the other user's information including the e-mail address “th@x.com” with the user identifier “1348” included in the another user contact information.

Also, the business card exchange processing subunit 1162 of the business card exchange processing unit 116 obtains business card exchange information associating the user identifier “1002” that is paired with the e-mail address “th@x.com” with the business card image of “Inoue Hajime” that is paired with the user identifier “1348” included in the another user contact information.

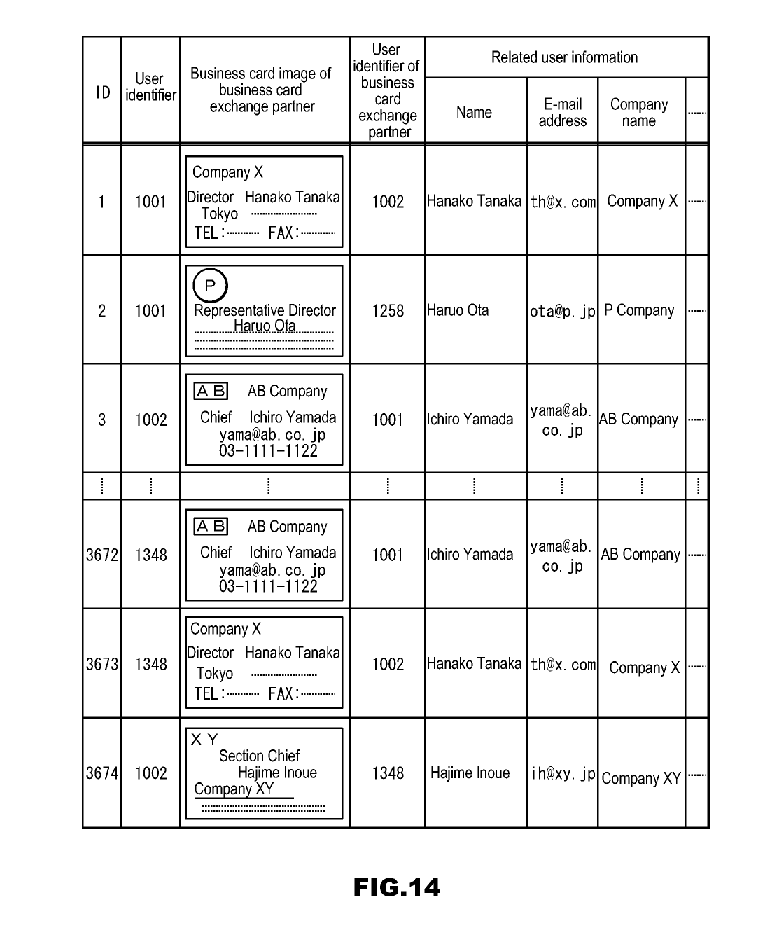

Next, the business card exchange processing subunit 1162 accumulates the two sets of business card exchange information that have been obtained in the business card exchange information management table. As a result, the business card exchange information management table shown in FIG. 14 is obtained. Note that here, it is not essential that the business card exchange processing unit 116 accumulates the business card exchange information (the record having “ID=3674” in FIG. 14) associating the user identifier “1002” that is paired with the e-mail address “th@x.com” with the business card image of “Inoue Hajime” that is paired with the user identifier “1348” included in the another user contact information, since “Inoue Hajime” has not input permission for business card exchange. With the processing described above, virtual business card exchange is realized.

Next, it is assumed that the user “Inoue Hajime” has been introduced to “Kato Saburo”, obtained the e-mail address “ks@d.com”, and input another user contact information including this e-mail address to the terminal apparatus 2.

Next, the terminal accepting unit 21 of the terminal apparatus 2 accepts the another user contact information that includes the user identifier “1348” of the user “Inoue Hajime” and the e-mail address “ks@d.com”. Then, the terminal sending unit 22 sends the another user contact information to the business card exchange information processing apparatus 1.

Next, the another user contact information accepting unit 113 receives the another user contact information that includes the e-mail address “ks@d.com”.

Then, the business card exchange processing unit 116 and the like perform business card exchange processing as described below. That is, the determination subunit 1161 constituting the business card exchange processing unit 116 searches the personal user information management table shown in FIG. 11 for user information that matches the other user's information including the e-mail address “ks@d.com”. As a result of the search, the determination subunit 1161 determines that the user information of “Kato Saburo” could not be obtained.

Next, the user registration prompting information sending subunit 1164 sends an e-mail prompting for user registration to the notification address “ks@d.com” included in the other user's information. It is assumed that a certain URL is stated in this e-mail.

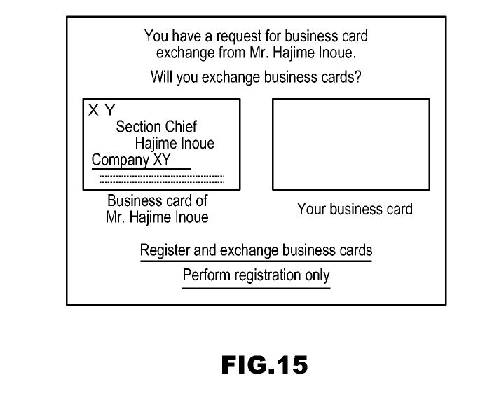

Next, it is assumed that “Kato Saburo” opened the received e-mail by using the terminal apparatus 2, read the text of the e-mail stating that there is an request for business card exchange, and clicked the URL with the mouse. Then, the screen shown in FIG. 15 is output to the terminal apparatus 2 of “Kato Saburo”. The screen shown in FIG. 15 is for prompting for both of user registration and business card exchange, or only user registration. Since the business card exchange information processing apparatus 1 does not hold the business card image of “Kato Saburo” therein, there is no image in the area “your business card” in FIG. 15.

Next, it is assumed that “Kato Saburo” clicked “Register and exchange business cards”. The screen prompting to upload the business card image is output to the terminal apparatus 2 of “Kato Saburo”. It is assumed that “Kato Saburo” has uploaded his own business card image to the business card exchange information processing apparatus 1 from the terminal apparatus 2.

Then, the terminal accepting unit 21 accepts a user registration command including the business card image. Next, the terminal sending unit 22 sends the user registration command including the business card image of “Kato Saburo” to the business card exchange information processing apparatus 1.

Next, the business card image accepting unit 104 of the business card exchange information processing apparatus 1 receives the user registration command including the business card image.

Then, the password input screen sending unit 105 reads out a password input screen from the password input screen storage unit 103, and sends that password input screen to the terminal apparatus 2 that has sent the user registration command.

Next, the terminal receiving unit 23 of the terminal apparatus 2 receives the password input screen. The terminal output unit 24 outputs the password input screen. Next, it is assumed that the user input his password “9kato1” twice in the password input screen as shown in FIG. 8, and clicked the “register” button.

Next, the terminal accepting unit 21 accepts a password sending command including the password “9kato1”. The terminal sending unit 22 then sends the password “9kato1” to the business card exchange information processing apparatus 1.

Next, the password receiving unit 106 of the business card exchange information processing apparatus 1 receives the password “9kato1”.

Next, the user identifier generation subunit 1071 constituting the user registration unit 107 generates a user identifier “1349” such that it is not the same as any other user identifier.

Next, the business card recognition subunit 1072 performs character recognition on the received business card image, thereby obtaining user information such as the name “Kato Saburo”, company name “Company d”, telephone number “03-9988-7777”, fax number “03-9988-7778” and the like.

Next, the personal user information accumulation subunit 1073 configures the personal user information “1349, 9kato1, Kato Saburo, ks@d.com, Company d - - - ” that includes the user identifier, password, user information, business card image and the like. Note that the e-mail address “ks@d.com” may be obtained from the another user contact information accepted by the another user contact information accepting unit 113, or by performing character recognition processing on the business card image.

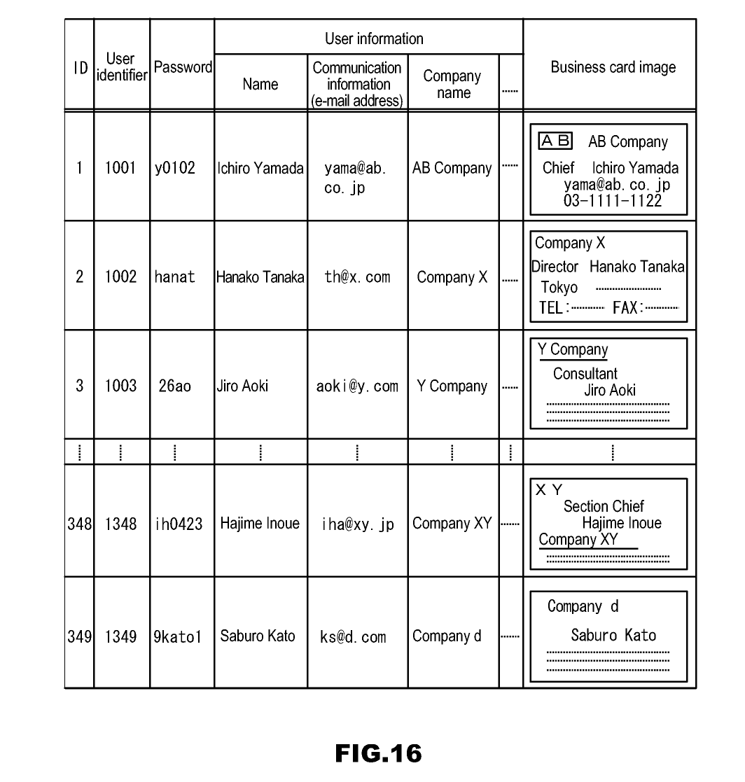

Then, the personal user information accumulation subunit 1073 accumulates the configured personal user information in the personal user information management table. As a result, the personal user information management table shown in FIG. 16 is obtained. The business card image is uploaded with the above-described processing, thereby completing user registration of “Kato Saburo”.

Next, since “Kato Saburo” has clicked “Register and exchange business cards”, he has given permission to exchange business cards with “Inoue Hajime”.

The business card exchange processing subunit 1162 obtains business card exchange information associating the business card image of “Kato Saburo” that is paired with the user information “ks@d.com” that matches the other user's information, with the user identifier “1348” in the another user contact information.

Also, the business card exchange processing subunit 1162 obtains business card exchange information associating the user identifier “1349” that is paired with the user information “ks@d.com” that matches the other user's information with the business card image of “Inoue Hajime” paired with the user identifier “1348” included in the another user contact information.

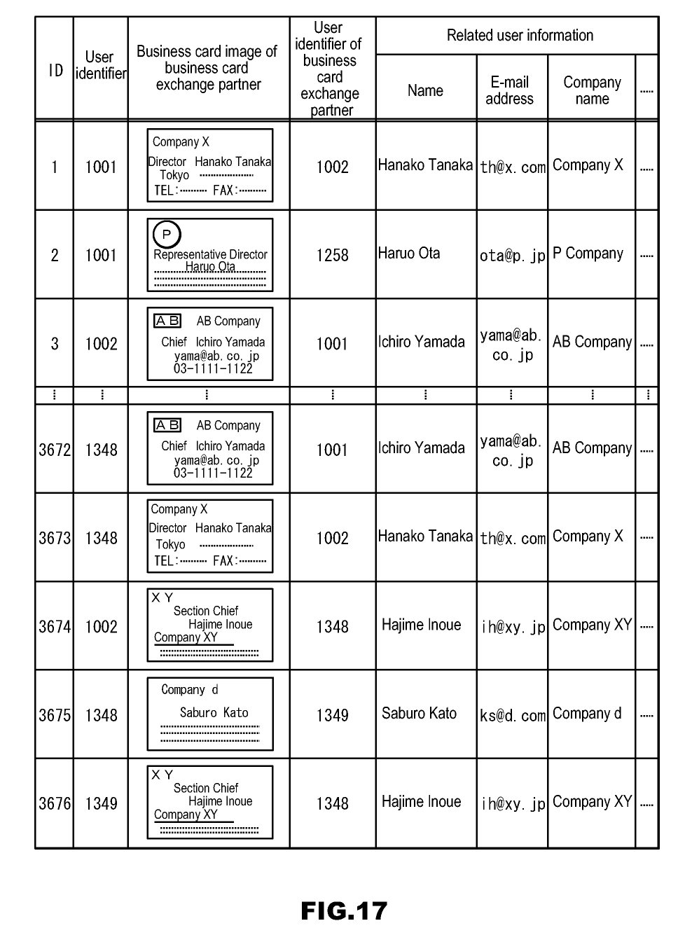

Next, the business card exchange processing subunit 1162 accumulates the two sets of business card exchange information that have been obtained in the business card exchange information management table. As a result, the business card exchange information management table shown in FIG. 17 is obtained. With the processing described above, both user registration and virtual business card exchange are realized.

Next, it is assumed that “Yamada Ichiro” has input his user identifier “1001”, password “y0102” into the terminal apparatus 2 in order to log on to the business card exchange information processing apparatus 1.

Next, the terminal accepting unit 21 accepts the user identifier “1001” and the like, the terminal sending unit 22 sends the user identifier “1001” and the like to the business card exchange information processing apparatus 1.

Next, an unshown authorization unit of the business card exchange information processing apparatus 1 searches the personal user information management table by using the user identifier “1001” and the password “y0102”, and detects that the pair of the user identifier “1001” and the password “y0102” is registered.

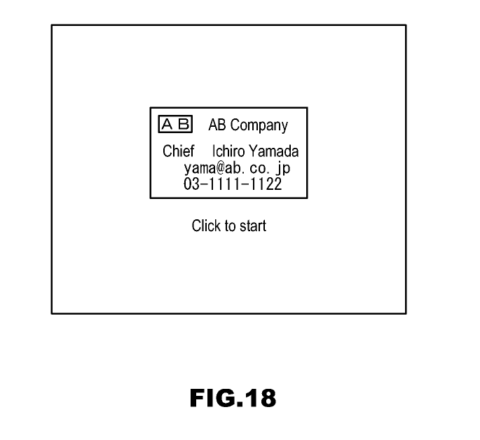

Then, an unshown start screen sending unit of the business card exchange information processing apparatus 1 sends the start screen shown in FIG. 18 to the terminal apparatus 2. Note that the start screen sending unit reads out a business card image that is paired with the user identifier “1001” and the password “y0102”, configures a screen in which the read-out business card image serves as a start button, and sends the screen to the terminal apparatus 2.

The terminal receiving unit 23 of the terminal apparatus 2 of “Yamada Ichiro” receives the start screen. The terminal output unit 24 outputs the start screen received by the terminal receiving unit 23.

Next, it is assumed that “Yamada Ichiro” clicked on the button configured of his own business card image, thereby enabling various types of processing (e.g., input of a business card output instruction) with respect to the business card exchange information processing apparatus 1.

Next, it is assumed that “Yamada Ichiro” has input the business card output instruction to the terminal apparatus 2. The business card output instruction is assumed to include the user identifier “1001” and the password “y0102” of “Yamada Ichiro”.

Then, the terminal accepting unit 21 accepts the business card output instruction, and the terminal sending unit 22 sends the business card output instruction to the business card exchange information processing apparatus 1.

Next, the business card output instruction accepting unit 110 receives a business card output instruction including the user identifier “1001” and the password “y0102”.

Next, the business card image obtaining unit 111 reads out at least one business card image or at least one set of related user information that is associated with the user identifier “1001” included in the business card output instruction, from the business card exchange information management table. Note that it is preferable that if there is a business card image associated with the user identifier “1001” included in the business card output instruction, the business card image obtaining unit 111 reads out the business card image, and if not, reads out other available information (generally, related user information).

Next, the business card image output unit 112 sends at least one business card image or the like that has been read out to the terminal apparatus 2.

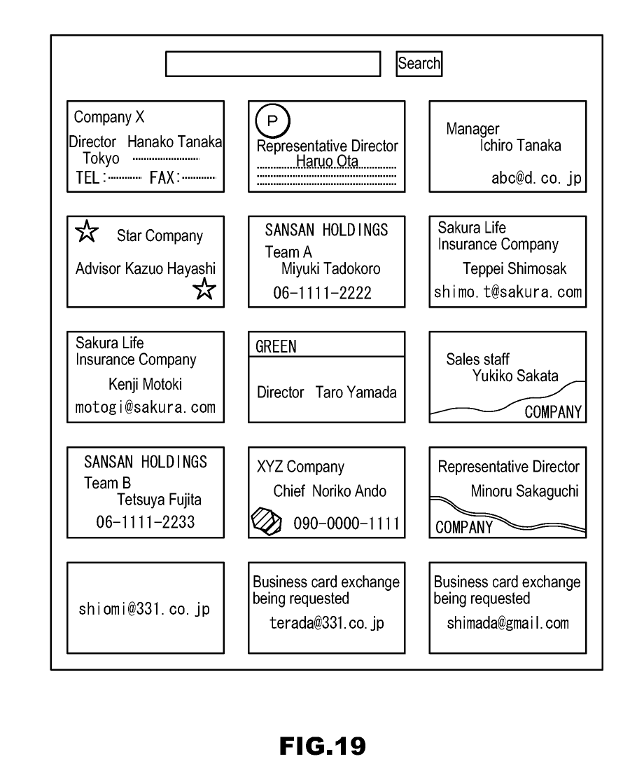

Next, the terminal receiving unit 23 of the terminal apparatus 2 of “Yamada Ichiro” receives at least one business card image or the like. Then, the terminal output unit 24 outputs the business card images and the like received by the terminal receiving unit 23 as shown in FIG. 19. In FIG. 19, if a request is being made for business card exchange, such an effect is output on the corresponding business card image or the like. If there is no available business card image in FIG. 19, only information of another person such as an e-mail address is output. Note that FIG. 19 is merely an example of how the business card images that have been obtained through business card exchange may be output, and it is obvious that there is no restriction to how the business card images may be output.

As described above, with Embodiment 1, a virtual business card exchange can be realized. Therefore, it is possible to expand a personal network by using information and communication technology.

Also, with Embodiment 1, it is possible to manage information such as an e-mail address alone of a person obtained by contacting that person, and it is also possible to prompt that person to register him/herself to the system or to exchange business cards by using such information. Therefore, the number of users of the business card exchange information processing apparatus can be effectively increased, thereby effectively promoting business card exchange.

Also, with Embodiment 1, it is possible to perform the virtual business card exchange only when the user has given permission therefor. Thus the user can perform the virtual business card exchange safely.

Also, with Embodiment 1, it is possible to perform user registration by sending a business card image. Therefore, users can very easily perform user registration.

Note that in Embodiment 1, an embodiment is mainly described in which the virtual business card exchange is performed only when the user has given permission therefor, but a virtual business card exchange also may be performed without requiring user's permission. In such a case, virtual business card exchange can be performed very simply and in a short time.

Also, with Embodiment 1, if each user registers his/her latest business card information and business card image, each user can always obtain and use the latest business card information and business card images of other users with whom business cards were exchanged.

Furthermore, the processing in Embodiment 1 may be realized by software. Such software may be distributed by downloading of software product or the like. In addition, such software may be recorded on a recording medium such as a CD-ROM and distributed. Note that this applies to other embodiments of the invention as well. Software that realizes the business card exchange information processing apparatus 1 of Embodiment 1 may be a program as described below. That is, this program allows storage in a storage medium of at least two sets of personal user information, each set of personal user information including a user identifier that is information for identifying a user, user information that is information relating to the user, and a business card image of the user, and at least one set of business card exchange information, each business card exchange information associating a user identifier with a business card image of a user with whom the user identified by the user identifier has exchanged business cards, and causes a computer to function as an another user contact information accepting unit that accepts, from one user, another user contact information that includes the user identifier of the one user and another user's information, which is information relating to another user, and a business card exchange processing unit that, if the another user contact information accepting unit has accepted another user contact information, searches the storage medium by using the other user's information included in the another user contact information as a key, and accumulates, in the storage medium, business card exchange information associating a business card image that is paired with user information matching the other user's information with the user identifier included in the another user contact information.

Also, with the program, it is preferable that the computer is caused to function such that the business card exchange information is information associating with each other a user identifier, a business card image of a user, and related user information, which is information relating to another user who has had contact with the user, and the business card exchange processing unit includes a determination subunit that, if the another user contact information accepting unit has accepted another user contact information, searches the storage medium by using the other user's information included in the another user contact information as a key, and determines whether or not there is user information matching the other user's information, and a business card exchange processing subunit that, if the determination subunit has determined that there is user information matching the other user's information, accumulates, in the storage medium, business card exchange information associating a business card image that is paired with the user information matching the other user's information with the user identifier included in the another user contact information.

Also, with the program, it is preferable that the computer is caused to function such that the business card exchange processing unit further includes a related user information accumulation subunit that, if the determination subunit has determined that there is no user information matching the other user's information, accumulates, in the storage medium, the other user's information that is included in the another user contact information as the related user information associated with the user identifier included in the another user contact information that is accepted by the another user contact information accepting unit, or a user registration prompting information sending subunit that, if the determination subunit has determined that there is no user information matching the other user's information, sends information prompting for user registration to a notification address included in the other user's information.

Also, with the program, it is preferable that the computer is caused to function such that the user information includes user notification address information indicating an address for an inquiry to a user identified by a user identifier, and a business card exchange asking unit that, if the another user contact information accepting unit has accepted another user contact information, obtains, from the storage medium, user notification address information that is paired with the other user's information included in the another user contact information, and performs a query as to whether or not to exchange business cards, using the user notification address information, and an answer accepting unit that accepts an answer to the query as to whether or not to exchange business cards are further included, and if the answer accepted by the answer accepting unit is an answer agreeing to exchange business cards, the business card exchange processing unit accumulates, in the storage medium, business card exchange information associating a business card image that is paired with the user information matching the other user's information with the user identifier included in the another user contact information.

Also, with the program, it is preferable that the computer is caused to function such that the personal user information includes a business card image of a user and a password, and a password input screen storage unit in which a password input screen for inputting a password is stored, a business card image accepting unit that accepts a business card image of a user, a password input screen sending unit that sends a password input screen to a terminal apparatus after the business card image has been accepted, a password receiving unit that receives a password from the terminal apparatus in response to sending the password input screen, and a user registration unit that accumulates, in the storage medium, personal user information that includes the business card image received by the business card image accepting unit and the password received by the password receiving unit are further included.

Also, with the program, it is preferable that the computer is caused to function such that the user registration unit includes a user identifier generation subunit that generates a user identifier such that it is not the same as any other user identifier, and a personal user information accumulation subunit that accumulates, in the storage medium, personal user information that includes the user identifier generated by the user identifier generation subunit, the business card image received by the business card image accepting unit, and the password received by the password receiving unit.

Also, with the program, it is preferable that the computer is caused to function such that the user registration unit further includes a business card recognition subunit that performs character recognition on the business card image and obtains user information including at least one of a name, company name, e-mail address, telephone number, fax number and job title, and the personal user information accumulation subunit accumulates, in the storage medium, personal user information that includes the user information obtained by the business card recognition subunit, the user identifier generated by the user identifier generation subunit, the business card image accepted by the business card image accepting unit, and the password received by the password receiving unit.

Also, with the program, it is preferable that the computer is caused to function such that a business card output instruction accepting unit that accepts a business card output instruction instructing to output a business card image of another user with whom business cards have been exchanged, and includes a user identifier, a business card image obtaining unit that, if the business card output instruction has been accepted, obtains at least one business card image associated with the user identifier included in the business card output instruction by using the business card exchange information in the storage medium, and a business card image output unit that outputs the at least one business card image obtained by the business card image obtaining unit are further included.

### Embodiment 2

In Embodiment 2, a business card management system is described in which user information of at least one user in the same group as the user identified by a user identifier that has been input is received from a server, and virtual business card exchange is realized by using the user information.

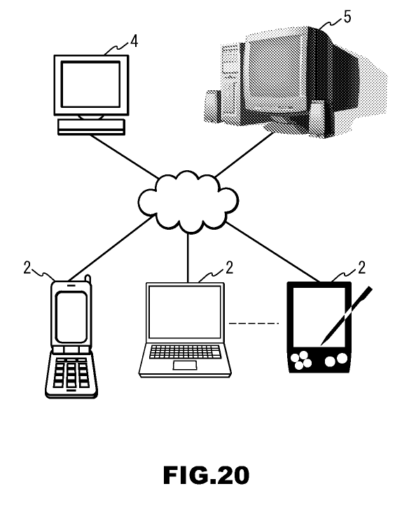

FIG. 20 is a conceptual diagram of a business card management system 3 in Embodiment 2. The business card management system 3 includes a business card exchange information processing apparatus 4, a server 5 and at least one terminal apparatus 2. The server 5 is a server that manages user groups, such as an SNS server or a company server. Note that the number of groups is generally two or more, but may be one.

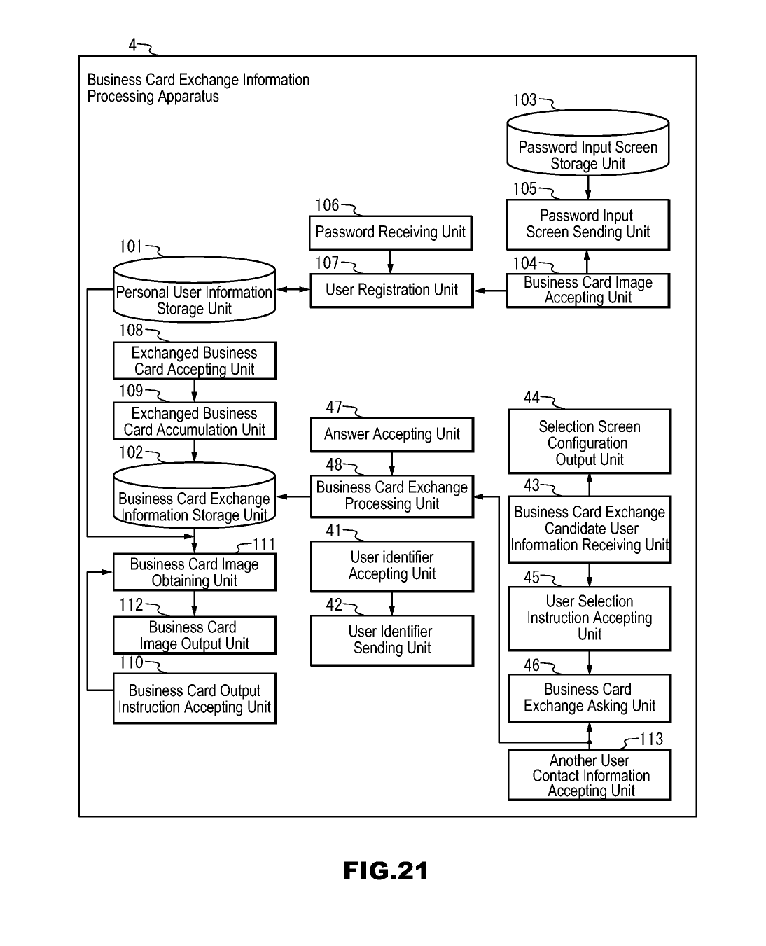

FIG. 21 is a block diagram of the business card exchange information processing apparatus 4 constituting the business card management system 3 in Embodiment 2.

The business card exchange information processing apparatus 4 includes a personal user information storage unit 101, a business card exchange information storage unit 102, a password input screen storage unit 103, a business card image accepting unit 104, a password input screen sending unit 105, a password receiving unit 106, a user registration unit 107, an exchanged business card accepting unit 108, an exchanged business card accumulation unit 109, a business card output instruction accepting unit 110, a business card image obtaining unit 111, a business card image output unit 112, an another user contact information accepting unit 113, a user identifier accepting unit 41, a user identifier sending unit 42, a business card exchange candidate user information receiving unit 43, a selection screen configuration output unit 44, a user selection instruction accepting unit 45, a business card exchange asking unit 46, an answer accepting unit 47 and a business card exchange processing unit 48.

The user registration unit 107 includes a user identifier generation subunit 1071, a business card recognition subunit 1072, and a personal user information accumulation subunit 1073.

The business card exchange processing unit 48 includes a determination subunit 1161, a business card exchange processing subunit 1162, and a related user information accumulation subunit 1163.

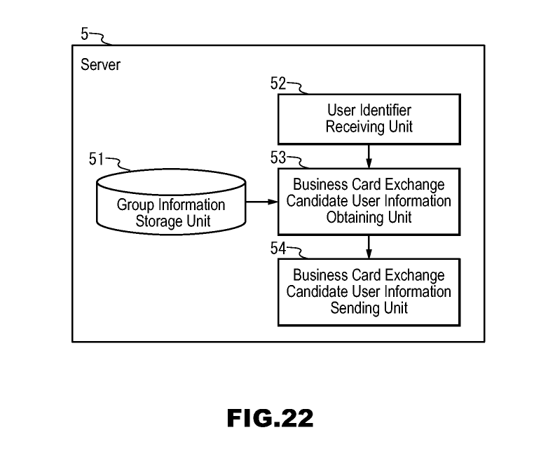

FIG. 22 is a block diagram of the server 5 constituting the business card management system 3 in Embodiment 2.

The server 5 includes a group information storage unit 51, a user identifier receiving unit 52, a business card exchange candidate user information obtaining unit 53 and a business card exchange candidate user information sending unit 54.

The terminal accepting unit 21 accepts information and commands. The information and commands are, for example, user identifiers, answers to the query as to whether or not to exchange business cards, and the like.

The terminal sending unit 22 sends information and commands accepted by the terminal accepting unit 21 to the business card exchange information processing apparatus 4. The terminal sending unit 22 also may send the user identifiers to the server 5. The terminal sending unit 22 is generally realized by a wireless or wired communication means, but may also be realized by a broadcasting means.

The terminal receiving unit 23 receives information and commands from the business card exchange information processing apparatus 4. The information and commands are, for example, at least one business card image, queries as to whether or not to exchange business cards, and the like. The terminal receiving unit 23 is generally realized by a wireless or wired communication means, but may be realized by a means for receiving broadcasting.

The terminal output unit 24 outputs information and commands received from the business card exchange information processing apparatus 4, for example. Here, “output” represents a concept that includes output to a display, projection by a projector, printing with a printer, sending to an outside device (e.g., display device), accumulation in a recording medium, delivery of processing results to other processing apparatus or other program. The terminal output unit 24 may or may not include an output device such as a display. The terminal output unit 24 can be realized by a driver software of an output device, or driver software of an output device and an output device, etc.

The user identifier accepting unit 41 accepts user identifiers. “Accept” here generally means reception from the terminal apparatus 2. Note that the user identifier accepting unit 41 may accept the user identifiers from users. Also, the “user identifiers” noted here are, generally, user identifiers managed by the server 5. Note that the user identifiers managed by the server 5 may be the same as those managed by the business card exchange information processing apparatus 4. The user identifier accepting unit 41 is generally realized by a wireless or wired communication means, but may be realized by a broadcasting means.

The user identifier sending unit 42 sends the user identifier accepted by the user identifier accepting unit 41 to the server 5. The sending of the user identifier noted here has the same meaning as the sending of a command prompting the server 5 to send user information of a user belonging to the same group as the user identified by the user identifier. This command includes a user identifier. Note that the user information of a user belonging to the same group as the user identified by the user identifier is business card exchange candidate user information as described below. The user identifier sending unit 42 is generally realized by a wireless or wired communication means, but may be realized by a broadcasting means.

The business card exchange candidate user information receiving unit 43 receives the business card exchange candidate user information from the server 5, in response to the sending of the user identifier (sending of the command described above). The business card exchange candidate user information is user information of at least one user who is a candidate for business card exchange. The business card exchange candidate user information is at least one set of user information included in the group information having the same group identifier as that paired with the user identifier. The business card exchange candidate user information receiving unit 43 is generally realized by a wireless or wired communication means, but may be realized by a broadcasting means.

The selection screen configuration output unit 44 configures a selection screen by using at least one set of user information included in the business card exchange candidate user information that has been received by the business card exchange candidate user information receiving unit 43, and outputs the selection screen. The selection screen is a screen for selecting a user with whom business cards are exchanged. It is not necessary that the selection screen includes the entire user information, and the selection screen may include only the name and sex, for example. “Output” here generally means sending to the terminal apparatus 2. Note that the selection screen may have any structure, such as HTML data, text data, or programs for configuring the screen.

Also, the selection screen configuration output unit 44 may select at least one set of user information included in the business card exchange candidate user information that has been received by the business card exchange candidate user information receiving unit 43, the business card image corresponding to that user information being present in the personal user information storage unit 101, and use the selected user information to configure and output a selection screen.

Note that the selection screen configuration output unit 44 generally uses part (e.g., name, age, birth date) of at least one set of user information included in the business card exchange candidate user information that has been received by the business card exchange candidate user information receiving unit 43 to search the personal user information storage unit 101, and selects only user information with respect to which matching information is stored in the personal user information storage unit 101. The selection screen configuration output unit 44 configures a selection screen based on the selected user information and outputs the selection screen. Here, the selection screen configuration output unit 44 generally obtains user information including a user identifier managed by the business card exchange information processing apparatus 4 from the personal user information storage unit 101.

The selection screen configuration output unit 44 is generally realized by a wireless or wired communication means, but may be realized by a broadcasting means.

The user selection instruction accepting unit 45 accepts a user selection instruction instructing to select a user with whom business cards are exchanged. The user selection instruction may be input by any means, such as a keyboard, mouse, and menu screen. The user selection instruction accepting unit 45 can be realized by a device driver of the input means such as a keyboard, menu screen control software, or the like.

The business card exchange asking unit 46 obtains at least one set of user notification address information included in at least one set of user information corresponding to the user selection instruction, and performs a query as to whether or not to exchange business cards by using the user notification address information. Note that this “query” may be performed by sending a screen for answering to the query to the notification address indicated by the user notification address information, or may be performed by sending a message requesting for an answer to the query. Note that a query as to whether or not to exchange business cards includes, for example, information prompting for a business card exchange and URI specifying a Web page for inputting the answer.

If the another user contact information accepting unit 113 has accepted another user contact information, the business card exchange asking unit 46 obtains, from the personal user information storage unit 101, the user notification address information that is paired with the other user's information included in the another user contact information, and uses the user notification address information to perform a query as to whether or not to exchange business cards. This operation is the same as that of the business card exchange asking unit 114.

The business card exchange asking unit 46 can be generally realized by an MPU, memory or the like. The processing procedure of the business card exchange asking unit 46 is generally realized by software, and the software for this is recorded in a recording medium such as a ROM. Note that the processing procedure also may be realized by hardware (dedicated circuitry).

The answer accepting unit 47 accepts an answer to the query as to whether or not to exchange business cards. The answer is either an answer permitting business card exchange or an answer refusing business card exchange. “Accept” here generally means receiving by a communication means such as a network, but the accepting means is not limited to this, and may involve receiving by fax and acceptance by manual input, for example.

The business card exchange processing unit 48 performs business card exchange processing. The business card exchange processing is virtual business card exchange processing. That is, in the business card exchange processing, if a business card image of at least one person with whom a certain user has exchanged business cards is output, the business card image of the person with whom business cards were exchanged is also output. In the business card exchange processing, in the case where the another user contact information accepting unit 113 has accepted another user contact information, the personal user information storage unit 101 is searched by using the other user's information included in the another user contact information as a key, and business card exchange information associating the business card image that is paired with user information matching the other user's information with the user identifier included in the another user contact information is accumulated in the business card exchange information storage unit 102.

If the answer accepting unit 47 has accepted an answer agreeing to exchange business cards, then the business card exchange processing unit 48 may accumulate, in the business card exchange information storage unit 102, business card exchange information associating the business card image that is paired with user information matching the other user's information with the user identifier included in the another user contact information.

Also, the business card exchange processing unit 48 may search the personal user information storage unit 101 by using, as a key, one or more sets of at least one set of user information included in the business card exchange candidate user information that has been received by the business card exchange candidate user information receiving unit 43, and accumulate, in the business card exchange information storage unit 102, business card exchange information associating at least one business card image that is paired with the user information matching any of the one or more sets of user information with the user identifier (user identifier corresponding to the user identifier accepted by the user identifier accepting unit 41 (user identifier managed by the server 5)). Note that the user identifier mentioned here is a user identifier managed by the business card exchange information processing apparatus 4.

Furthermore, if the answer accepting unit 47 has accepted an answer agreeing to exchange business cards, then the business card exchange processing unit 48 may accumulate, in the business card exchange information storage unit 102, business card exchange information associating a business card image that is paired with the user notification address information corresponding to the answer with the user identifier (user identifier corresponding to the user identifier accepted by the user identifier accepting unit 41). Note that the user identifier mentioned here is a user identifier managed by the business card exchange information processing apparatus 4.

The business card exchange processing unit 48 can be generally realized by an MPU, memory or the like. The processing procedure of the business card exchange processing unit 48 is generally realized by software, and the software for this is recorded in a recording medium such as a ROM. Note that the processing procedure also may be realized by hardware (dedicated circuitry).

The group information storage unit 51 constituting the server 5 can have at least one set of group information stored therein. Note that it is preferable that the group information storage unit 51 has two or more sets of group information stored therein. The group information is information associating the user identifier for identifying a user, user information that is information relating to the user, and the group identifier for identifying at least one group to which the user belongs with each other. The user information is, for example, the name, company name, job title, e-mail address, URL of the company, telephone number, and fax number. The user identifier mentioned here is a user identifier managed by the server 5.

The group information storage unit 51 preferably is a nonvolatile recording medium, but can also be realized by a volatile recording medium. There is no restriction to the process by which the group information is stored in the group information storage unit 51. For example, group information may be stored in the group information storage unit 51 via a recording medium, group information sent via a communication line or the like may be stored in the group information storage unit 51, or group information input via an input device may be stored in the group information storage unit 51.

The user identifier receiving unit 52 receives a user identifier from the business card exchange information processing apparatus 4. The user identifier receiving unit 52 is generally realized by a wireless or wired communication means, but may be realized by a broadcasting means.

The business card exchange candidate user information obtaining unit 53 obtains the business card exchange candidate user information from the group information storage unit 51. The business card exchange candidate user information is at least one set of user information included in the group information having the same group identifier as that paired with the user identifier received by the user identifier receiving unit 52. Note that the user information obtained by the business card exchange candidate user information obtaining unit 53 may be part of the user information stored in the group information storage unit 51. For example, if the user information stored in the group information storage unit 51 is the name, company name, job title, e-mail address, URL of the company, telephone number and fax number, then the business card exchange candidate user information obtaining unit 53 may obtain only the name and company name as the user information. Note that the business card exchange candidate user information generally does not include user information corresponding to the user identifier received by the user identifier receiving unit 52.

The business card exchange candidate user information obtaining unit 53 can be generally realized by an MPU, memory or the like. The processing procedure of the business card exchange candidate user information obtaining unit 53 is generally realized by software, and the software for this is recorded in a recording medium such as a ROM. Note that the processing procedure also may be realized by hardware (dedicated circuitry).

The business card exchange candidate user information sending unit 54 sends the business card exchange candidate user information obtained by the business card exchange candidate user information obtaining unit 53 to the business card exchange information processing apparatus 4.

The business card exchange candidate user information sending unit 54 is generally realized by a wireless or wired communication means, but may be realized by a broadcasting means.

Next, the operation of the business card management system 3 is described. Note that the operation of the business card management system 3 that was already described in Embodiment 1 is not described here.

First, the operation of the terminal apparatus 2 is described. The terminal accepting unit 21 of the terminal apparatus 2 accepts a user identifier from the user. Next, the terminal sending unit 22 sends the user identifier accepted by the terminal accepting unit 21 to the business card exchange information processing apparatus 4.

Then, the terminal receiving unit 23 receives a selection screen from the business card exchange information processing apparatus 4 in response to sending the user identifier by the terminal sending unit 22. The terminal output unit 24 then outputs the selection screen received by the terminal receiving unit 23.

Next, the user selects the item corresponding to the person with whom he/she desires to exchange business cards on the selection screen. Specifically, the user inputs a user selection instruction. The terminal accepting unit 21 accepts the user selection instruction from the user. Note that the user selection instruction includes information identifying at least one user (e.g., at least one user identifier). The user identifier mentioned here is a user identifier managed by the business card exchange information processing apparatus 4.

Next, the terminal sending unit 22 sends a user selection instruction accepted by the terminal accepting unit 21 to the business card exchange information processing apparatus 4.

Then, the business card exchange information processing apparatus 4 and the like execute the business card exchange processing described below. The terminal receiving unit 23 may receive from the business card exchange information processing apparatus 4 information notifying the terminal receiving unit 23 of the user with whom business cards have been exchanged. In such a case, the terminal output unit 24 outputs information notifying the terminal receiving unit 23 of the user.

Note that in the case where the terminal apparatus 2 has accepted a user identifier, the business card exchange processing may be completed without the user inputting the user selection instruction.

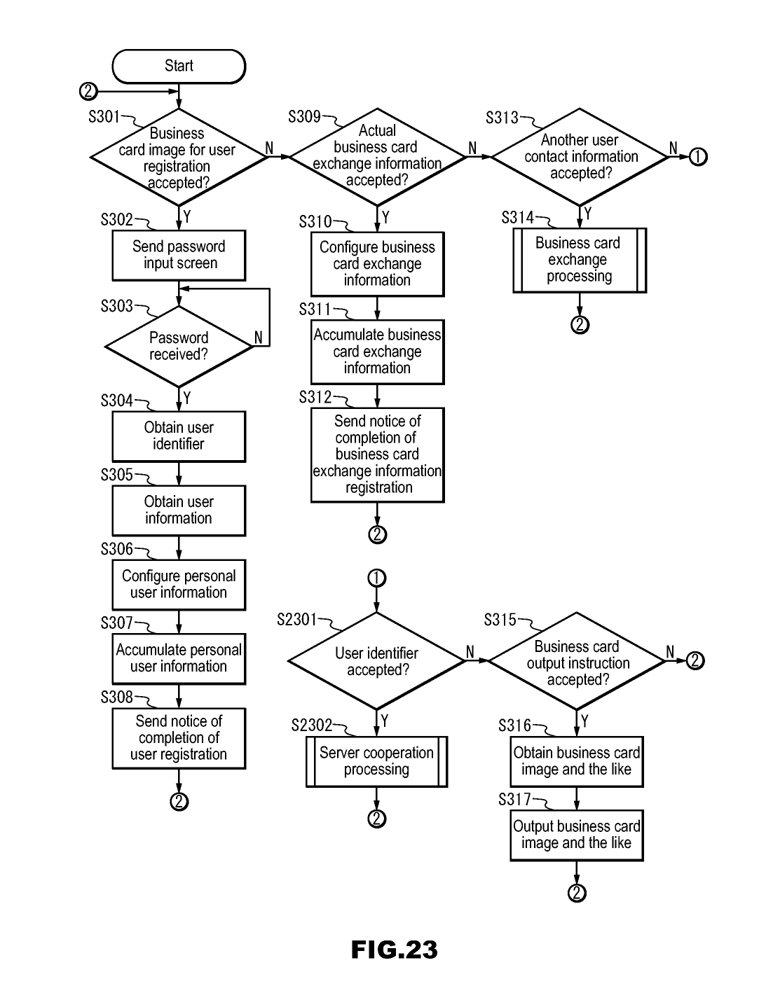

Next, the operation of the business card exchange information processing apparatus 4 is described with reference to the flowchart in FIG. 23. In the flowchart of FIG. 23, steps that are the same as those in the flowchart of FIG. 3 are not described.

(Step S2301) The user identifier accepting unit 41 determines whether the user identifier has been accepted. If the user identifier has been accepted, the procedure proceeds to step S2302, and if not, the procedure proceeds to step S315. Note that the user identifier mentioned here is a user identifier managed by the server 5.

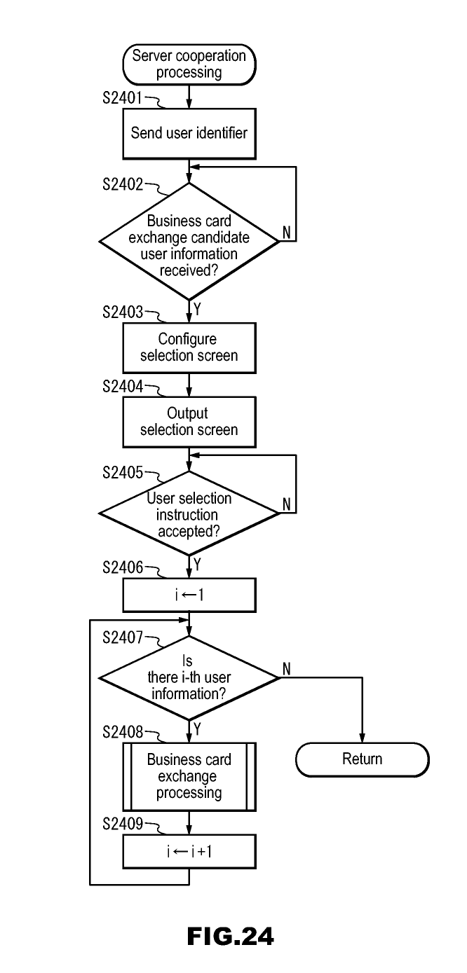

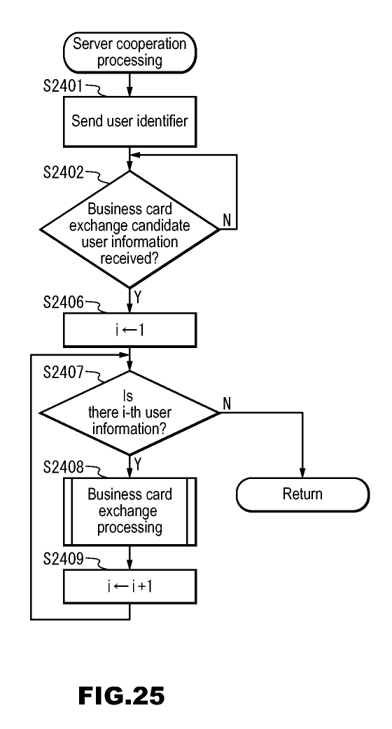

(Step S2302) The business card exchange information processing apparatus 4 uses user information stored in the server 5 to perform server cooperation processing for performing virtual business card exchange. The server cooperation processing is described with reference to the flowcharts in FIGS. 24 and 25.

In the flowchart of FIG. 23, the processing ends due to turning off power or a process-ending interrupt.

Next, a first example of the server cooperation processing in step S2302 is described with reference to the flowchart in FIG. 24. In the flowchart of FIG. 23, steps that are the same as those in the flowchart in FIG. 3 are not described.

(Step S2401) The user identifier sending unit 42 sends the accepted user identifier to the server 5.

(Step S2402) The business card exchange candidate user information receiving unit 43 determines whether the business card exchange candidate user information has been received from the server 5 in response to sending the user identifier in step S2401. If the business card exchange candidate user information has been received, the procedure proceeds to step S2403, and if not, the procedure returns to step S2402.

(Step S2403) The selection screen configuration output unit 44 configures a selection screen by using at least one set of user information included in the business card exchange candidate user information that has been received by the business card exchange candidate user information receiving unit 43. The selection screen configuration output unit 44 searches the personal user information storage unit 101 by using, as a key, information that can identify a user (e.g., name, birth date, telephone number), which is part of at least one set of user information included in the business card exchange candidate user information, for example, and obtains at least one set of user information (user information managed by the business card exchange information processing apparatus 4) from the personal user information storage unit 101. Then, the selection screen configuration output unit 44 configures a selection screen including at least one selection menu item corresponding to at least one set of user information that has been obtained. Note that it may occur that the information of a user corresponding to the user information included in the business card exchange candidate user information is not stored in the personal user information storage unit 101.

(Step S2404) The selection screen configuration output unit 44 outputs the selection screen configured in step S2403. “Output” here generally means sending to the terminal apparatus 2.

(Step S2405) The user selection instruction accepting unit 45 determines whether the user selection instruction has been accepted in response to the output of the selection screen in step S2404. If the user selection instruction has been accepted, the procedure proceeds to step S2406, and if not, the procedure returns to step S2405. Note that the acceptance of the user selection instruction mentioned here generally means reception of the user selection instruction from the terminal apparatus 2.

(Step S2406) The business card exchange asking unit 46 sets counter i to 1.

(Step S2407) The business card exchange asking unit 46 determines whether there is an i-th user information that corresponds to at least one user selected by the user selection instruction. If there is an i-th user information, the procedure proceeds to step S2408, and if not, the procedure returns to superordinate processing.

(Step S2408) The business card exchange asking unit 46 and the like perform business card exchange processing by using the i-th user information. The business card exchange processing is described with reference to FIG. 4.

(Step S2409) The business card exchange asking unit 46 increments the counter i by one. The procedure returns to step S2407.

Note that in the business card exchange processing in step S2408 in the flowchart of FIG. 24, it is not necessary to perform the registration/business card exchange processing in step S409. This also applies to the flowchart in FIG. 25.

Next, a second example of the server cooperation processing in step S2302 is described with reference to the flowchart in FIG. 25. The second example of the server cooperation processing differs from the first example in that the user of the terminal apparatus 2 cannot select a user with whom business cards are exchanged. In the flowchart of FIG. 25, the second example is realized by steps S2401, S2402, S2406, S2407, S2408 and S2409 of FIG. 24.

The specific operation of the business card management system 3 in Embodiment 2 is described below. FIG. 20 shows a schematic diagram of the business card management system 3. Also, in Embodiment 3, the server 5 is an SNS server, for example.

The personal user information storage unit 101 of the business card exchange information processing apparatus 4 holds the personal user information management table shown in FIG. 6.

Also, the business card exchange information storage unit 102 holds the business card exchange information management table shown in FIG. 7.

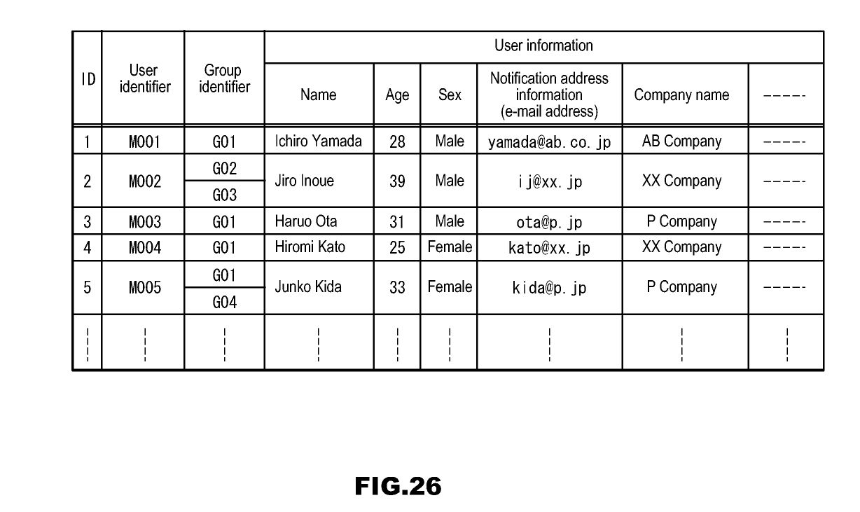

Furthermore, the group information management table shown in FIG. 26 is stored in the group information storage unit 51 of the server 5. At least one record, each record including “ID”, “user identifier”, “group identifier”, and “user information”, is stored in the group information management table. The “user information” includes “name”, “age”, “sex” “notification address information (e-mail address)”, and “company name”.

In such a case, it is assumed that the user of the terminal apparatus 2, “Yamada Ichiro”, has input his user identifier “M001” to the terminal apparatus 2 in order to exchange business cards with other users belonging to the same group in a SNS community administered by the server 5. Note that the user identifier “M001” is a user identifier managed by the server 5.

Next, the terminal accepting unit 21 of the terminal apparatus 2 accepts the user identifier “M001”. Next, the terminal sending unit 22 sends the user identifier “M001” accepted by the terminal accepting unit 21 to the business card exchange information processing apparatus 4.

Next, the user identifier accepting unit 41 of the business card exchange information processing apparatus 4 receives the user identifier “M001” from the terminal apparatus 2.

Next, the user identifier sending unit 42 sends the received user identifier “M001” to the server 5.

Next, the user identifier receiving unit 52 of the server 5 receives the user identifier “M001” from the business card exchange information processing apparatus 4.

Then, the business card exchange candidate user information obtaining unit 53 of the server 5 obtains the business card exchange candidate user information from the group information management table (FIG. 26) by using the user identifier “M001”. That is, the business card exchange candidate user information obtaining unit 53 searches the group information management table (FIG. 26) by using the user identifier “M001” as a key, thereby obtaining the group identifier “G01”. The business card exchange candidate user information obtaining unit 53 obtains records having the group identifier “G01” (ID=3, 4, 5, . . . ). Note that in this case, generally, the business card exchange candidate user information obtaining unit 53 does not obtain the record having the user identifier “M001” (ID=1).

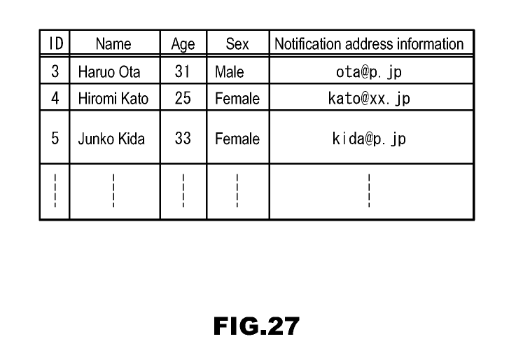

Next, the business card exchange candidate user information obtaining unit 53 obtains predetermined information (e.g., name, age, sex and communication information) with respect to the information of each obtained record. That is, the business card exchange candidate user information obtaining unit 53 obtains, for example, the business card exchange candidate user information shown in FIG. 27.

Next, the business card exchange candidate user information sending unit 54 sends the business card exchange candidate user information (FIG. 27) obtained by the business card exchange candidate user information obtaining unit 53 to the business card exchange information processing apparatus 4.

Next, the business card exchange candidate user information receiving unit 43 of the business card exchange information processing apparatus 4 receives the business card exchange candidate user information shown in FIG. 27.

Then, the selection screen configuration output unit 44 configures a selection screen by using the business card exchange candidate user information shown in FIG. 27. Here, the selection screen configuration output unit 44 removes user information of users who have already exchanged business cards with the user “Yamada Ichiro” out of the business card exchange candidate user information shown in FIG. 27. That is, the selection screen configuration output unit 44 holds the user identifier “1001”, which has been input to log on to the system by the user who has input the user identifier “M001” for the server 5, and obtains user identifiers “1002”, “1258” and the like of the users who have exchanged business cards with the user identified by that user identifier “1001” from the business card exchange information management table shown in FIG. 7. Then, the selection screen configuration output unit 44 searches the personal user information management table shown in FIG. 6 for user information identified by the user identifiers “1002”, “1258” and the like, and obtains this user information. The selection screen configuration output unit 44 removes the user information (in this case, user information of “Ota Haruo” having the user identifier “1258”) that matches the obtained user information from the business card exchange candidate user information. The selection screen configuration output unit 44 may use only user information of users that is managed by the personal user information management table out of the received business card exchange candidate user information to configure the selection screen. Here, the selection screen configuration output unit 44 is assumed to have configured the selection screen based on the user information of “Kato Hiromi”, “Kida Junko” and the like. Note that it is obvious that the selection screen configuration output unit 44 may configure the selection screen by using the entire user information in the received business card exchange candidate user information.

Next, the selection screen configuration output unit 44 sends the configured selection screen to the terminal apparatus 2. Here, for example, it is assumed that the selection screen is written in HTML. Since a technique for configuring a selection screen written in HTML is a known technique, it is not described here in detail.

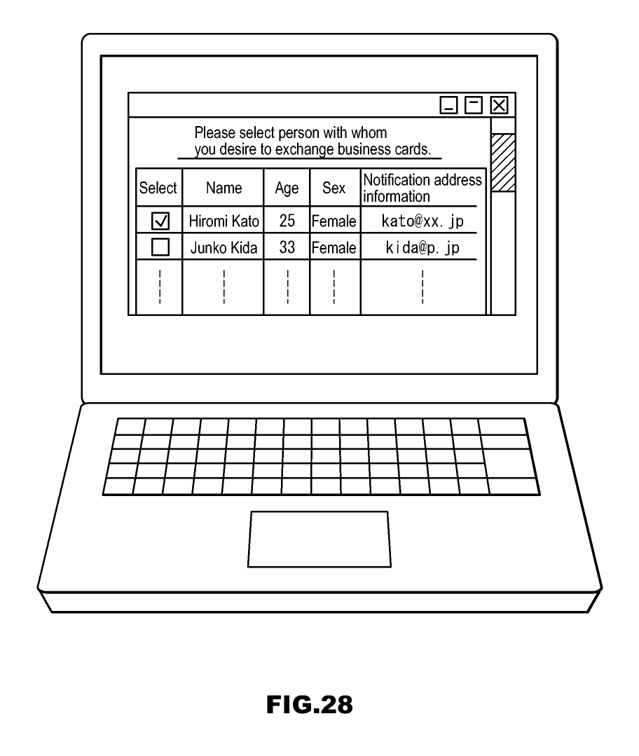

Next, the terminal receiving unit 23 of the terminal apparatus 2 receives the selection screen from the business card exchange information processing apparatus 4 in response to sending the user identifier “M001” by the terminal sending unit 22. The terminal output unit 24 outputs the selection screen received by the terminal receiving unit 23. Here, the selection screen is shown in FIG. 28.

Next, it is assumed that the user of the terminal apparatus 2, “Yamada Ichiro”, desired to exchange business cards with “Kato Hiromi”, and has ticked the corresponding selection item (check box).

Next, the terminal accepting unit 21 of the terminal apparatus 2 accepts the user selection instruction selecting “Kato Hiromi” from the user.

The terminal sending unit 22 then sends the user selection instruction selecting “Kato Hiromi” that has been accepted by the terminal accepting unit 21 to the business card exchange information processing apparatus 4. This user selection instruction may be, for example, “ID=4”, which identifies “Kato Hiromi”.

Next, the user selection instruction accepting unit 45 of the business card exchange information processing apparatus 4 receives the user selection instruction (e.g., “ID=4”) in response to the sending of the selection screen.

Next, the business card exchange asking unit 46 and the like of the business card exchange information processing apparatus 4 perform business card exchange processing by using the user information, “name: Kato Hiromi, age: 25, sex: female, communication information: kato@xx.jp”.

Specifically, the business card exchange asking unit 114 performs a query as to whether or not to exchange business cards with the user of the terminal apparatus 2 to the notification address indicated by the communication information “kato@xx.jp” included in the user information. Note that the query as to whether or not to exchange business cards can be performed by, for example, sending an e-mail as shown in FIG. 13 including the URL for outputting the Web page and a message prompting for a business card exchange.

Then, it is assumed that “Kato Hiromi” went to the URL indicated in the e-mail, displaying a screen similar to that shown in FIG. 13 (the business card exchange partner is Mr. Ichiro Yamada) on her terminal apparatus 2, and clicked the anchor “Exchange business cards” on the screen by using an input means such as a mouse. The terminal sending unit 22 then sends the information “Exchange business cards” accepted by the terminal accepting unit 21 to the business card exchange information processing apparatus 4.

Next, the answer accepting unit 47 accepts an answer agreeing to exchange business cards. The business card exchange processing unit 48 determines that the answer accepted by the answer accepting unit 47 is “OK”, which permits business card exchange.

The business card exchange processing subunit 1162 of the business card exchange processing unit 48 obtains business card exchange information associating the business card image that is paired with the user information including the e-mail address “kato@xx.jp” (the business card image of Ms. Hiromi Kato) with the user identifier “1001”.

Also, the business card exchange processing subunit 1162 of the business card exchange processing unit 48 obtains business card exchange information associating the user identifier “1619” that is paired with the e-mail address “kato@xx.jp” with the business card image of “Yamada Ichiro” that is paired with the user identifier “1001”.

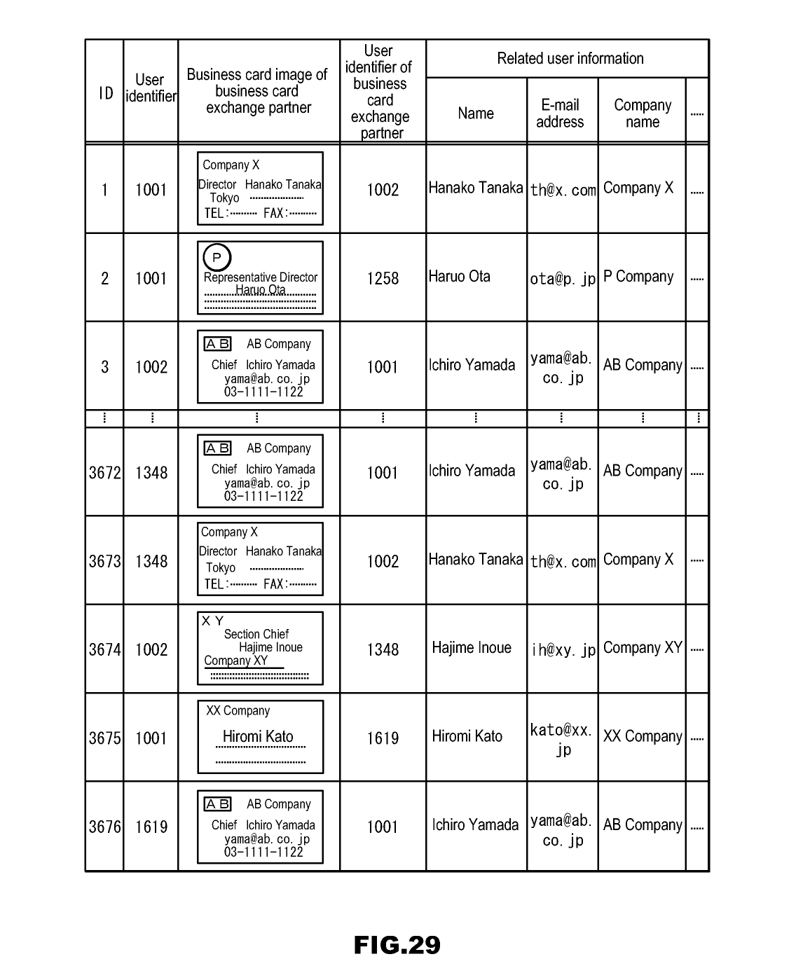

Next, the business card exchange processing subunit 1162 accumulates the two sets of business card exchange information that have been obtained in the business card exchange information management table. As a result, the business card exchange information management table shown in FIG. 29 is obtained. Virtual business card exchange is realized by the processing described above.

As described above, with Embodiment 2, it is possible to realize virtual business card exchange by using information of an existing personal network (other servers) such as SNS. Therefore, it is possible to further expand a personal network by using information and communication technology.

Note that although the communication information of the user in the foregoing embodiments is an e-mail address, any information that enables communication can be used as the communication information. The communication information may be, for example, the user identifier (ID) managed in the server (e.g., SNS server). In such a case, the communication for exchanging business cards is performed via the server (e.g., SNS server). Such communication is performed by using, for example, direct messages of SNS.

Also, software that realizes the business card exchange information processing apparatus 4 in Embodiment 2 may be a program as described below. That is, this program allows storage in a storage medium of at least two sets of personal user information, each set of personal user information including a user identifier that is information for identifying a user, user information that is information relating to the user, and a business card image of the user, and at least one set of business card exchange information, each business card exchange information associating a user identifier with a business card image of a user with whom the user identified by the user identifier has exchanged business cards, and causes a computer to function as a user identifier accepting unit that accepts a user identifier, a user identifier sending unit that sends the user identifier to a server, a business card exchange candidate user information receiving unit that receives, from the server, business card exchange candidate user information that is at least one set of user information of at least one user belonging to the same group as the user identified by the user identifier in response to sending the user identifier, and a business card exchange processing unit that searches the storage medium by using one or more sets of the at least one set of user information included in the business card exchange candidate user information that has been received by the business card exchange candidate user information receiving unit as a key, and accumulates, in the storage medium, business card exchange information associating at least one business card image that is paired with user information matching any of the one or more sets of user information with the user identifier.

Also, with the program, it is preferable that the computer is caused to function such that the user information includes user notification address information indicating an address for an inquiry to the user identified by the user identifier, and a selection screen configuration output unit that configures a selection screen for selecting a user with whom business cards are exchanged by using at least one set of user information included in the business card exchange candidate user information that has been received by the business card exchange candidate user information receiving unit, and outputs the selection screen, a user selection instruction accepting unit that accepts a user selection instruction selecting a user with whom business cards are exchanged, a business card exchange asking unit that obtains at least one set of user notification address information included in at least one set of user information that corresponds to the user selection instruction, and performs a query as to whether or not to exchange business cards by using the user notification address information, and an answer accepting unit that accepts an answer to the query as to whether or not to exchange business cards are further included, and if the answer accepted by the answer accepting unit is an answer agreeing to exchange business cards, the business card exchange processing unit accumulates, in the storage medium, business card exchange information associating a business card image that is paired with the user notification address information corresponding to the answer with the user identifier.

Also, with the program, it is preferable that the query as to whether or not to exchange business cards includes information prompting for a business card exchange and a URI specifying a Web page for inputting the answer.

### Embodiment 3

In Embodiment 3, a business card management system is described in which a business card image that has been already input by the third party is used for user registration. Note that although the business card management system in Embodiment 3 has a function of performing user registration by using a business card image as in Embodiment 1, the business card management system in Embodiment 3 may not have this function.

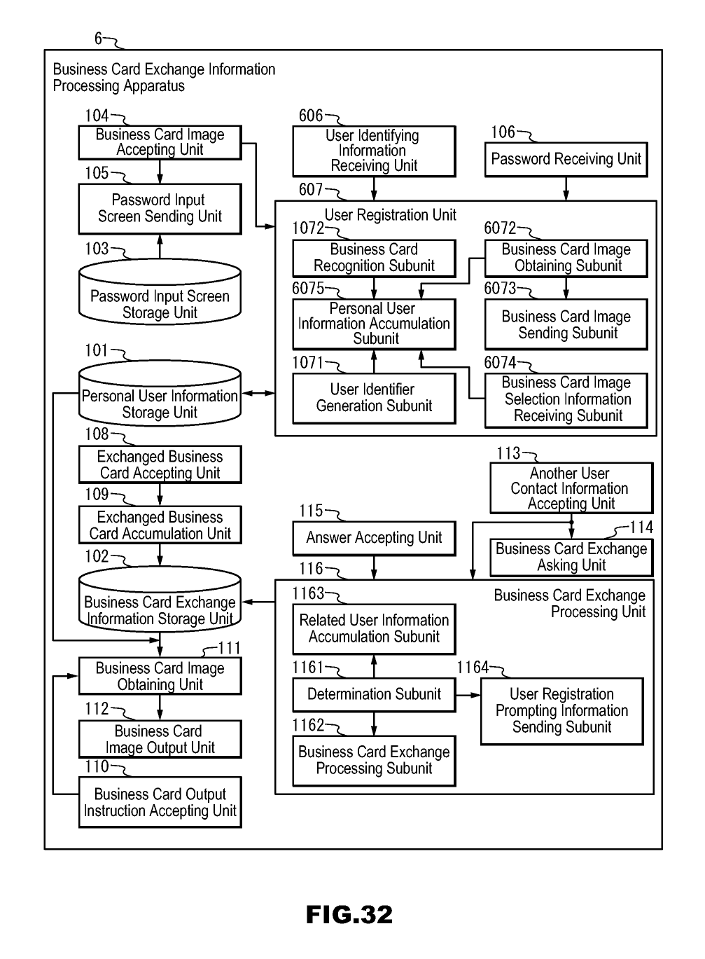

FIG. 32 is a block diagram of a business card exchange information processing apparatus 6 constituting the business card management system in Embodiment 3. The business card management system includes the business card exchange information processing apparatus 6 and two or more terminal apparatuses 2. The business card exchange information processing apparatus 6 and the terminal apparatuses 2 are capable of communicating with each other.

The business card exchange information processing apparatus 6 includes a personal user information storage unit 101, a business card exchange information storage unit 102, a password input screen storage unit 103, a business card image accepting unit 104, a password input screen sending unit 105, a password receiving unit 106, a user identifying information receiving unit 606, a user registration unit 607, an exchanged business card accepting unit 108, an exchanged business card accumulation unit 109, a business card output instruction accepting unit 110, a business card image obtaining unit 111, a business card image output unit 112, an another user contact information accepting unit 113, a business card exchange asking unit 114, an answer accepting unit 115 and a business card exchange processing unit 116.

Also, the user registration unit 607 includes a user identifier generation subunit 1071, a business card recognition subunit 1072, a business card image obtaining subunit 6072, a business card image sending subunit 6073, a business card image selection information receiving subunit 6074, and a personal user information accumulation subunit 6075.

Also, the terminal apparatus 2 includes a terminal accepting unit 21, a terminal sending unit 22, a terminal receiving unit 23 and a terminal output unit 24.

The user identifying information receiving unit 606 receives user identifying information for identifying a user to be registered from the terminal apparatus 2. The user identifying information is, for example, a name and an e-mail address. Also, the user identifying information is, for example, a name, an e-mail address and a password. Another example of the user identifying information is a name and an e-mail address only. The user identifying information may also be a company name and a name, for example. Also, the user identifying information may be information that specifies the terminal apparatus 2 of the user from which an e-mail prompting for user registration has been sent. The user identifying information receiving unit 606 is generally realized by a wireless or wired communication means, but may be realized by a means for receiving broadcasting.

The user registration unit 607 searches business card images stored in the personal user information storage unit 101 by using the user identifying information that has been received by the user identifying information receiving unit 606, and stores, in the personal user information storage unit 101, personal user information having the whole or part of the user identifying information and a business card image that has been retrieved by the search. Note that the personal user information having a business card image may be personal user information having information that specifies the business card image.

The business card image obtaining subunit 6072 searches at least one business card image stored in the business card exchange information storage unit 102 by using the user identifying information (e.g., e-mail address) that has been received by the user identifying information receiving unit 606, and obtains one or more business card images.

In the case where the business card image obtaining subunit 6072 has obtained two or more business card images, the business card image sending subunit 6073 sends the two or more business card images to the terminal apparatus 2 that has sent the user identifying information.

The business card image selection information receiving subunit 6074 receives business card image selection information that specifies the business card image selected by the user from among the two or more business card images sent by the business card image sending subunit 6073 from the terminal apparatus 2. The business card image selection information may be the selected business card image itself, or may be information that specifies the selected business card image.

The personal user information accumulation subunit 6075 accumulates, in the personal user information storage unit 101, personal user information having the whole or part of the user identifying information received by the user identifying information receiving unit 606, and a business card image. Here, the business card image refers to the business card image obtained by the business card image obtaining subunit 6072, or the business card image specified by the business card image selection information received by the business card image selection information receiving subunit 6074. The personal user information accumulation subunit 6075 also realizes the same function as the personal user information accumulation subunit 1073.

The user registration unit 607 can be generally realized by a wireless or wired communication means, and an MPU, memory or the like.

Here, the terminal accepting unit 21 accepts, for example, the user identifying information, the business card image selection information, or the like.

Here, the terminal sending unit 22 sends the user identifying information or the business card image selection information, or the like accepted by the terminal accepting unit 21, for example.

Here, the terminal receiving unit 23 receives two or more business card images from the business card exchange information processing apparatus 6, for example.

Here, the terminal output unit 24 outputs the two or more business card images received by the terminal receiving unit 23, for example.

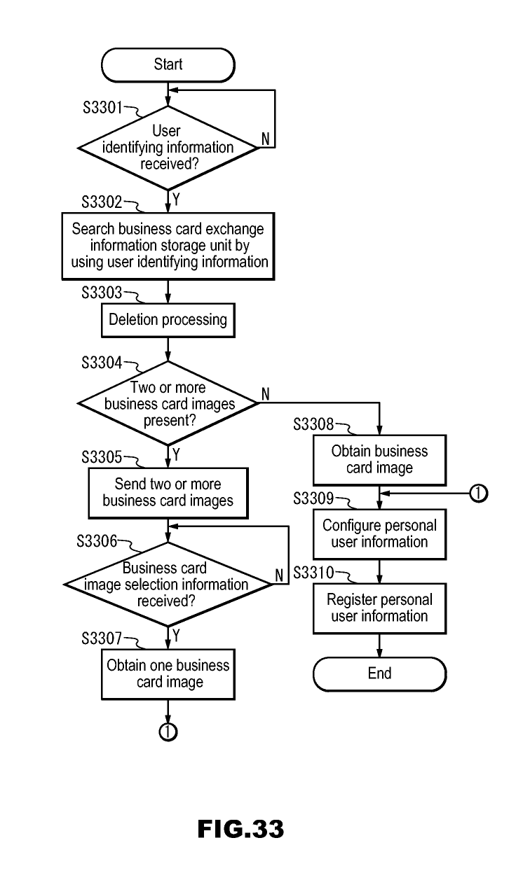

Next, the operation of the business card management system will be described. The business card management system in Embodiment 3 differs from the business card management system in Embodiment 1 only in the user registration processing, in which a business card image that has been already input by the third party is used. This user registration processing will be described with reference to the flowchart in FIG. 33.

(Step S3301) The user identifying information receiving unit 606 of the business card exchange information processing apparatus 6 determines whether user identifying information has been received from the terminal apparatus 2. If the user identifying information has been received, the processing proceeds to step S3302, and if not, the processing returns to step S3301.

(Step S3302) The business card image obtaining subunit 6072 searches the business card exchange information storage unit 102 by using the user identifying information received in step S3301, and obtains one or more business card image.

(Step S3303) The business card image obtaining subunit 6072 performs deletion processing on the one or more business card image obtained in step S3302. That is, in the case where two or more business card images have been received, and if there are at least two business card images that are the same, the business card image obtaining subunit 6072 performs deletion processing so as to leave only one business card image. Note that the same business card images may be business card images the similarity between which is larger than or equal to a predetermined threshold, or business card images whose respective user information sets (company name, e-mail address, title, or the like) are the same, for example.

(Step S3304) The business card image sending subunit 6073 determines whether there are two or more business card images. If there are two or more business card images, the processing proceeds to step S3305, and if not, the processing proceeds to step S3308.

(Step S3305) The business card image sending subunit 6073 sends the two or more business card images to the terminal apparatus 2.

(Step S3306) The business card image selection information receiving subunit 6074 determines whether business card image selection information has been received from the terminal apparatus 2. If the business card image selection information has been received, the processing proceeds to step S3307, and if not, the processing returns to step S3306.

(Step S3307) The personal user information accumulation subunit 6075 obtains the business card image corresponding to the business card image selection information received in step S3306. The processing then proceeds to step S3309.

(Step S3308) The personal user information accumulation subunit 6075 obtains the business card image retrieved in step S3302.

(Step S3309) The personal user information accumulation subunit 6075 configures personal user information by using the whole or part of the user identifying information received in step S3301, and the business card image. Note that the personal user information accumulation subunit 6075 may configure the personal user information by using the information obtained by performing character recognition on the business card image.

(Step S3310) The personal user information accumulation subunit 6075 accumulates the personal user information configured in step S3309 in the personal user information storage unit 101.

Note that in the flowchart in FIG. 33, it is preferable that after the completion of the user registration, the business card exchange information processing apparatus 6 sends information indicating the completion of the user registration to the terminal apparatus 2.

Also, if the business card image cannot be obtained in step S3302, as described in Embodiment 1, the user registers him or herself by using his or her own business card image.

Furthermore, in the flowchart of FIG. 33, even in the case where there is only one business card image in step S3304, the business card image sending subunit 6073 may send that one business card image to the terminal apparatus 2, and receive the information indicating the confirmation that the user has input to the terminal apparatus 2, or may receive another business card image from the terminal apparatus 2 of the user. In this case, it is preferable that when the business card exchange information processing apparatus 6 has received the information indicating the confirmation from the terminal apparatus 2, the personal user information accumulation subunit 6075 accumulates the business card image retrieved in step S3302, and when another business card image has been received from the terminal apparatus 2, the personal user information accumulation subunit 6075 accumulates the received business card image. Note that the information indicating the confirmation refers to information indicating the confirmation of using the received business card image.

As described above, with Embodiment 3, user registration can be performed in a simple manner.

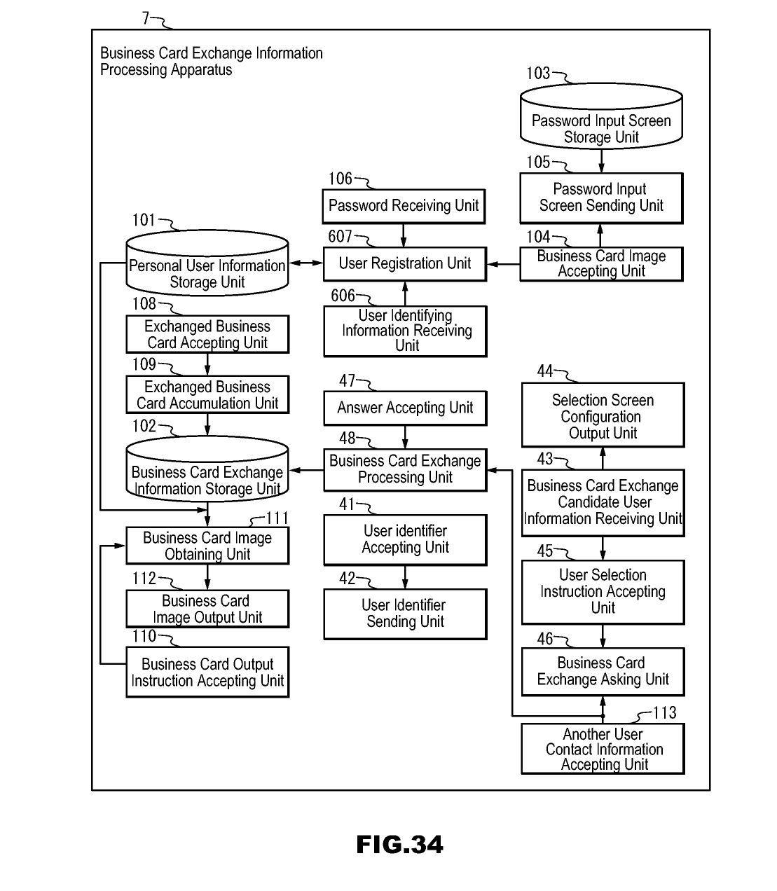

Note that the method for the user registration described in Embodiment 3 can be applied also to the business card management system in Embodiment 2. In this case, the business card management system is configured as shown in FIG. 34. This business card management system includes a business card exchange information processing apparatus 7 and two or more terminal apparatuses 2.

Also, needless to say, the business card exchange information processing apparatus 6 has a function of “registering and exchanging business cards”, which is the user registration described in Embodiment 1. In such a case, the user identifying information received by the business card exchange information processing apparatus 6 is, for example, information that specifies the terminal apparatus 2. Note that the user identifying information in this case corresponds to the information for “registering and exchanging business cards”.

The user registration unit 607 configures the personal user information by using the user information corresponding to the information that specifies the terminal apparatus 2 and the business card image. Then, the user registration unit 607 accumulates the personal user information in the personal user information storage unit 101. Note that the user information corresponding to the information that specifies the terminal apparatus 2 and the business card image refer to, for example, the user information corresponding to the e-mail address of the sent e-mail and the business card image.

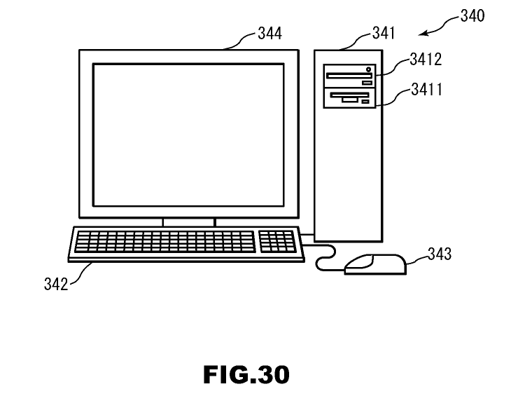

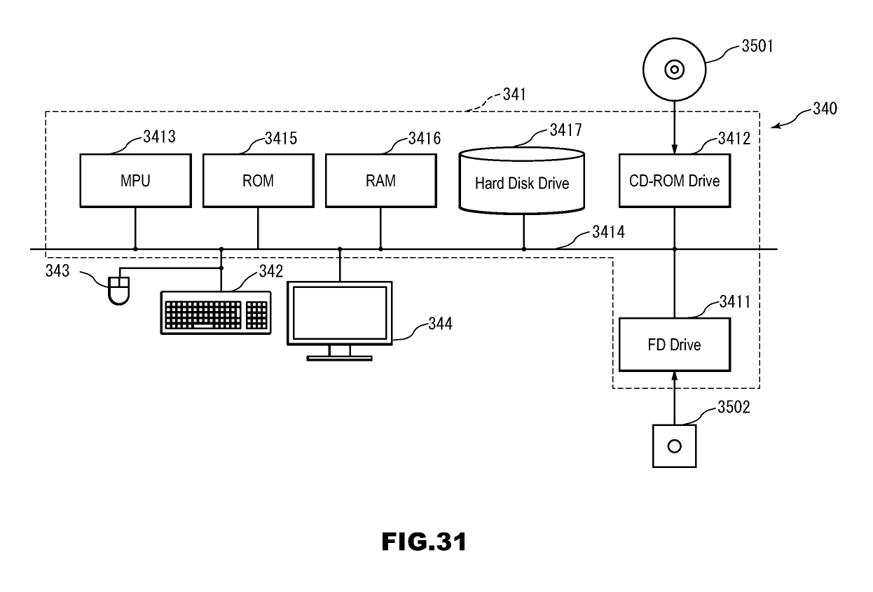

FIG. 30 shows the external appearance of a computer that executes the programs described in this specification to realize the business card exchange information processing apparatus 1, the terminal apparatus 2, and the like in the foregoing embodiments. The foregoing embodiments may be realized using computer hardware and a computer program executed thereon. FIG. 30 is a schematic view of a computer system 340. FIG. 31 is a diagram showing the internal configuration of the computer system 340.

In FIG. 30, the computer system 340 includes a computer 341 including an FD drive 3411 and a CD-ROM drive 3412, a keyboard 342, a mouse 343, and a monitor 344.

In FIG. 31, the computer 341 includes not only the FD drive 3411 and the CD-ROM drive 3412, but also a RAM 3416 that is connected to an MPU 3413, a bus 3414 that is connected to the CD-ROM drive 3412 and the FD drive 3411, and a ROM 3415 in which a program such as a startup program is to be stored, and in which a command of an application program is temporarily stored and a temporary storage area is to be provided, and a hard disk 3417 in which an application program, a system program, and data are to be stored. Although not shown, the computer 341 may further include a network card that provides connection to a LAN.

The program for causing the computer system 340 to execute the functions of the business card exchange information processing apparatus 1, terminal apparatus 2 and the like in the foregoing embodiments may be stored in a CD-ROM 3501 or an FD 3502, which are inserted into the CD-ROM drive 3412 or the FD drive 3411, and may be transmitted to the hard disk 3417. Alternatively, the program may be transmitted to the computer 341 via a network (not shown) and stored in the hard disk 3417. At the time of execution, the program is loaded into the RAM 3416. The program may be loaded from the CD-ROM 3501 or the FD 3502, or directly from a network.

The program does not necessarily have to include, for example, an operating system (OS) or a third party program to cause the computer 341 to execute the functions of the business card management system and the like in the above-described embodiments. The program may only include a portion of command capable of calling an appropriate function (module) in a controlled mode and obtaining the desired results. The manner in which the computer system 340 operates is well known, and, thus, a detailed description thereof is omitted.

It should be noted that, in the program, in a step of sending information, a step of receiving information, or the like, a process performed by hardware, for example, a process performed by a modem or an interface card (a process that can be performed only by such hardware) is not included.

Furthermore, the computer that executes this program may be a single computer, or may be multiple computers. More specifically, centralized processing may be performed, or distributed processing may be performed.

Furthermore, in the foregoing embodiments, it will be appreciated that two or more communication means in one apparatus may be physically realized as one medium.

Furthermore, in the foregoing embodiments, each process (each function) may be realized as an integrated process using a single apparatus (system), or may be realized as a distributed process using multiple apparatuses.

The present invention is not limited to the embodiments set forth herein. Various modifications are possible within the scope of the present invention.

### INDUSTRIAL APPLICABILITY

As described above, the business card exchange information processing apparatus according to the present invention can realize virtual business card exchange and thus has an effect that the apparatus can expand a personal network by using information and communication technology, and, thus, this apparatus is useful as a business card management system and the like.

What is claimed is:

1. A business card exchange information processing apparatus, comprising:
a personal user information storage unit in which at least two sets of personal user information can be stored, each set of personal user information including a user identifier that is information for identifying a user, user information that is information relating to the user, and a business card image of the user;
a business card exchange information storage unit in which at least one set of business card exchange information can be stored, each set of business card exchange information associating a user identifier with a business card image of a user with whom the user identified by the user identifier has exchanged business cards;
an another user contact information accepting unit that accepts, from one user, another user contact information that includes the user identifier of the one user and another user's information, which is information relating to another user; and
a business card exchange processing unit that, if the another user contact information accepting unit has accepted another user contact information, searches the personal user information storage unit by using the other user's information included in the another user contact information as a key, and accumulates, in the business card exchange information storage unit, business card exchange information associating a business card image that is paired with user information matching the other user's information with the user identifier included in the another user contact information.

2. The business card exchange information processing apparatus according to claim 1,
wherein the business card exchange information is information associating with each other a user identifier, a business card image of a user, and related user information, which is information relating to another user who has had contact with the user, and
the business card exchange processing unit comprises:
a determination subunit that, if the another user contact information accepting unit has accepted another user contact information, searches the personal user information storage unit by using the other user's information included in the another user contact information as a key, and determines whether or not there is user information matching the other user's information; and
a business card exchange processing subunit that, if the determination subunit has determined that there is user information matching the other user's information, accumulates, in the business card exchange information storage unit, business card exchange information associating a business card image that is paired with the user information matching the other user's information with the user identifier included in the another user contact information.

3. The business card exchange information processing apparatus according to claim 2,
wherein the business card exchange processing unit further comprises:
a related user information accumulation subunit that, if the determination subunit has determined that there is no user information matching the other user's information, accumulates, in the business card exchange information storage unit, the other user's information that is included in the another user contact information as the related user information associated with the user identifier included in the another user contact information that is accepted by the another user contact information accepting unit; or
a user registration prompting information sending subunit that, if the determination subunit has determined that there is no user information matching the other user's information, sends information prompting for user registration to a notification address included in the other user's information.

4. The business card exchange information processing apparatus according to claim 1,
wherein the user information includes user notification address information indicating an address for an inquiry to a user identified by a user identifier,
the apparatus further comprises:
a business card exchange asking unit that, if the another user contact information accepting unit has accepted another user contact information, obtains, from the personal user information storage unit, user notification address information that is paired with the other user's information included in the another user contact information, and performs a query as to whether or not to exchange business cards, using the user notification address information; and
an answer accepting unit that accepts an answer to the query as to whether or not to exchange business cards, and
if the answer accepted by the answer accepting unit is an answer agreeing to exchange business cards, the business card exchange processing unit accumulates, in the business card exchange information storage unit, business card exchange information associating a business card image that is paired with the user information matching the other user's information with the user identifier included in the another user contact information.

5. The business card exchange information processing apparatus according to claim 1,
wherein the personal user information includes a business card image of a user and a password, and
the apparatus further comprises:
a password input screen storage unit in which a password input screen for inputting a password is stored;
a business card image accepting unit that accepts a business card image of a user;
a password input screen sending unit that sends a password input screen to a terminal apparatus after the business card image has been accepted;
a password receiving unit that receives a password from the terminal apparatus in response to sending the password input screen; and
a user registration unit that accumulates, in the personal user information storage unit, personal user information that includes the business card image received by the business card image accepting unit and the password received by the password receiving unit.

6. The business card exchange information processing apparatus according to claim 5,
wherein the user registration unit comprises:
a user identifier generation subunit that generates a user identifier such that it is not the same as any other user identifier; and
a personal user information accumulation subunit that accumulates, in the personal user information storage unit, personal user information that includes the user identifier generated by the user identifier generation subunit, the business card image received by the business card image accepting unit, and the password received by the password receiving unit.

7. The business card exchange information processing apparatus according to claim 6,
wherein the user registration unit further comprises a business card recognition subunit that performs character recognition on the business card image and obtains at least one piece of user information from the set consisting of a name, company name, e-mail address, telephone number, fax number and job title, and
the personal user information accumulation subunit accumulates, in the personal user information storage unit, personal user information that includes the user information obtained by the business card recognition subunit, the user identifier generated by the user identifier generation subunit, the business card image accepted by the business card image accepting unit, and the password received by the password receiving unit.

8. The business card exchange information processing apparatus according to claim 1, further comprising:
a business card output instruction accepting unit that accepts a business card output instruction instructing to output a business card image of another user with whom business cards have been exchanged, and includes a user identifier;
a business card image obtaining unit that, if the business card output instruction has been accepted, obtains at least one business card image associated with the user identifier included in the business card output instruction by using the business card exchange information in the business card exchange information storage unit; and
a business card image output unit that outputs the at least one business card image obtained by the business card image obtaining unit.

9. A business card exchange information processing apparatus constituting a business card management system that includes a business card exchange information processing apparatus and a server,
wherein the business card exchange information processing apparatus comprises:
a personal user information storage unit in which at least two sets of personal user information can be stored, each set of personal user information including a user identifier that is information for identifying a user, user information that is information relating to the user, and a business card image of the user;
a business card exchange information storage unit in which at least one set of business card exchange information can be stored, each set of business card exchange information associating a user identifier with a business card image of a user with whom the user identified by the user identifier has exchanged business cards;
a user identifier accepting unit that accepts a user identifier;
a user identifier sending unit that sends the user identifier to the server;
a business card exchange candidate user information receiving unit that receives business card exchange candidate user information from the server in response to sending the user identifier; and
a business card exchange processing unit that searches the personal user information storage unit by using one or more sets of the at least one set of user information included in the business card exchange candidate user information that has been received by the business card exchange candidate user information receiving unit as a key, and accumulates, in the business card exchange information storage unit, business card exchange information associating at least one business card image that is paired with user information matching any of the one or more sets of user information with the user identifier, and
the server comprises:
a group information storage unit in which at least two sets of group information can be stored, each set of group information associating with each other a user identifier for identifying a user, user information that is information relating to the user, and a group identifier for identifying at least one group to which the user belongs;
a user identifier receiving unit that receives a user identifier from the business card exchange information processing apparatus;
a business card exchange candidate user information obtaining unit that obtains, from the group information storage unit, business card exchange candidate user information, which is at least one set of user information included in group information having the same group identifier as that paired with the user identifier; and
a business card exchange candidate user information sending unit that sends the business card exchange candidate user information obtained by the business card exchange candidate user information obtaining unit to the business card exchange information processing apparatus.

10. The business card exchange information processing apparatus according to claim 9,
wherein the user information includes user notification address information indicating an address for an inquiry to the user identified by the user identifier,
the apparatus further comprises:
a selection screen configuration output unit that configures a selection screen for selecting a user with whom business cards are exchanged by using at least one set of user information included in the business card exchange candidate user information that has been received by the business card exchange candidate user information receiving unit, and outputs the selection screen;
a user selection instruction accepting unit that accepts a user selection instruction selecting a user with whom business cards are exchanged;
a business card exchange asking unit that obtains at least one set of user notification address information included in at least one set of user information that corresponds to the user selection instruction, and performs a query as to whether or not to exchange business cards by using the user notification address information; and
an answer accepting unit that accepts an answer to the query as to whether or not to exchange business cards, and
if the answer accepted by the answer accepting unit is an answer agreeing to exchange business cards, the business card exchange processing unit accumulates, in the business card exchange information storage unit, business card exchange information associating a business card image that is paired with the user notification address information corresponding to the answer with the user identifier.

11. The business card exchange information processing apparatus according to claim 10,
wherein the query as to whether or not to exchange business cards includes information prompting for a business card exchange and a URI specifying a Web page for inputting the answer.

12. A business card exchange information processing apparatus, comprising:
a personal user information storage unit in which at least two sets of personal user information can be stored, each set of personal user information including a user identifier that is information for identifying a user, user information that is information relating to the user, and a business card image of the user;
a business card exchange information storage unit in which at least one set of business card exchange information can be stored, each set of business card exchange information associating a user identifier with a business card image of a user with whom the user identified by the user identifier has exchanged business cards;
a user identifier accepting unit that accepts a user identifier;
a user identifier sending unit that sends the user identifier to a server;
a business card exchange candidate user information receiving unit that receives, from the server, business card exchange candidate user information that is at least one set of user information of at least one user belonging to the same group as the user identified by the user identifier in response to sending the user identifier; and
a business card exchange processing unit that searches the personal user information storage unit by using one or more sets of the at least one set of user information included in the business card exchange candidate user information that has been received by the business card exchange candidate user information receiving unit as a key, and accumulates, in the business card exchange information storage unit, business card exchange information associating at least one business card image that is paired with user information matching any of the one or more sets of user information with the user identifier.

13. A business card exchange information processing method realized by using an another user contact information accepting unit and a business card exchange processing unit, with which at least two sets of personal user information can be stored in a storage medium, each set of personal user information including a user identifier that is information for identifying a user, user information that is information relating to the user, and a business card image of the user, and at least one set of business card exchange information can be stored in the storage medium, each business card exchange information associating a user identifier with a business card image of a user with whom the user identified by the user identifier has exchanged business cards, the method comprising the steps of:
the another user contact information accepting unit accepting, from one user, another user contact information that includes the user identifier of the one user and another user's information, which is information relating to another user;
the business card exchange processing unit searching, if another user contact information has been accepted in the accepting step, the storage medium by using the other user's information included in the another user contact information as a key, and accumulating, in the storage medium, business card exchange information associating a business card image that is paired with user information matching the other user's information with the user identifier included in the another user contact information.

14. A recording medium having recorded therein a program, the program
allowing storage in a storage medium of at least two sets of personal user information, each set of personal user information including a user identifier that is information for identifying a user, user information that is information relating to the user, and a business card image of the user, and at least one set of business card exchange information, each business card exchange information associating a user identifier with a business card image of a user with whom the user identified by the user identifier has exchanged business cards, and
causing a computer to function as:
an another user contact information accepting unit that accepts, from one user, another user contact information that includes the user identifier of the one user and another user's information, which is information relating to another user; and
a business card exchange processing unit that, if the another user contact information accepting unit has accepted another user contact information, searches the storage medium by using the other user's information included in the another user contact information as a key, and accumulates, in the storage medium, business card exchange information associating a business card image that is paired with user information matching the other user's information with the user identifier included in the another user contact information.

15. A business card exchange information processing method realized by using a user identifier accepting unit, a user identifier sending unit, a business card exchange candidate user information receiving unit, and a business card exchange processing unit, with which at least two sets of personal user information can be stored in a storage medium, each set of personal user information including a user identifier that is information for identifying a user, user information that is information relating to the user, and a business card image of the user, and at least one set of business card exchange information can be stored in the storage medium, each business card exchange information associating a user identifier with a business card image of a user with whom the user identified by the user identifier has exchanged business cards, the method comprising the steps of:
the user identifier accepting unit accepting a user identifier;
the user identifier sending unit sending the user identifier to a server;
the business card exchange candidate user information receiving unit receiving, from the server, business card exchange candidate user information that is at least one set of user information of at least one user belonging to the same group as the user identified by the user identifier in response to sending the user identifier; and
the business card exchange processing unit searching the storage medium by using one or more sets of the at least one set of user information included in the business card exchange candidate user information that has been received in the receiving step as a key, and accumulating, in the storage medium, business card exchange information associating at least one business card image that is paired with user information matching any of the one or more sets of user information with the user identifier.

16. A recording medium having recorded therein a program, the program
allowing storage in a storage medium of at least two sets of personal user information, each set of personal user information including a user identifier that is information for identifying a user, user information that is information relating to the user, and a business card image of the user, and at least one set of business card exchange information, each business card exchange information associating a user identifier with a business card image of a user with whom the user identified by the user identifier has exchanged business cards, and
causing a computer to function as:
a user identifier accepting unit that accepts a user identifier;
a user identifier sending unit that sends the user identifier to a server;
a business card exchange candidate user information receiving unit that receives, from the server, business card exchange candidate user information that is at least one set of user information of at least one user belonging to the same group as the user identified by the user identifier in response to sending the user identifier; and
a business card exchange processing unit that searches the storage medium by using one or more sets of the at least one set of user information included in the business card exchange candidate user information that has been received by the business card exchange candidate user information receiving unit as a key, and accumulates, in the storage medium, business card exchange information associating at least one business card image that is paired with user information matching any of the one or more sets of user information with the user identifier.
